(19) United States
(12) Patent Application Publication
(10) Pub. No.: US 2019/0033185 A1
(43) Pub. Date: Jan. 31, 2019

(54) High Throughput Methods for Screening Chemical Reactions Using Reagent-Coated Bulking Agents

(71) Applicant: AbbVie Inc., North Chicago, IL (US)

(72) Inventors: Amanda Dombrowski, Chicago, IL (US); Noah P. Tu, Lincolnshire, IL (US); Ying Wang, Libertyville, IL (US)

(73) Assignee: AbbVie Inc., North Chicago, IL (US)

(21) Appl. No.: 16/042,378

(22) Filed: Jul. 23, 2018

Related U.S. Application Data
(60) Provisional application No. 62/538,932, filed on Jul. 31, 2017.

(51) Int. Cl. G01N 1/38; G01N 1/28; G01N 35/10

(52) U.S. Cl. CPC G01N 1/38; G01N 1/286; G01N 2001/002; G01N 35/1002; G01N 2001/386; G01N 35/1016

(57) ABSTRACT

Systems, methods, and compositions for high throughput screening of micro-scale chemical reactions are disclosed. In particular, systems, methods, and compositions for handling small amounts of solid reagent are disclosed. For example, mechanical mixing is employed to obtain reagent-coated bulking agents that can be used, inter alia, in high throughput methods for screening micro-scale chemical reactions.

### RELATED APPLICATION

This application claims the benefit of U.S. Provisional Application No. 62/538,932, filed Jul. 31, 2017 and U.S. Provisional Application No. 62/659,923, filed Apr. 19, 2018. Both applications are incorporated herein by reference.

### TECHNICAL FIELD

The present disclosure generally relates to bulking agents and, more specifically, to methods for mixing reagents and bulking agents to provide reagent-coated bulking agents that can be used, inter alia, in high throughput methods for screening chemical reactions

### BACKGROUND

The process of drug discovery involves not only identification and selection of candidate compounds from vast compound libraries but also the development and optimization of synthetic reactions to enable the creation of such libraries and, ultimately, scale up synthesis for more promising candidates.

The development and optimization of synthetic reactions, particularly for small molecules, is a tedious and time consuming process. In many instances, there is a limited amount of a starting material or core. Thus, sequential investigation and/or performance of micro-scale reactions can be employed to preserve these precious resources. However, sequential investigation results in a long turnaround time and micro-scale reactions are difficult to perform using current methods.

Chemical reaction screening can be time-, labor-, and resource-intensive. For example, screening of a large number of chemical reactions often requires a correspondingly large library of reagents to be generated. Oftentimes, the library of reagents is prepared manually, which results in a great amount of preparation time. Additionally, in some instances, the manual preparation of the reagents results in waste of the reagent and/or too much of the reagent being prepared for what is needed for the screening. Moreover, there is often difficulty in dispensing certain reagents at low amounts and the pharmaceutical industry has yet to develop a way to handle various types of chemical solids effectively at small scales.

Thus, there is a need in the art for simple, accurate and efficient ways for dispensing small amounts of chemicals (e.g., 0.1 to 1 mg) and yet obtain desired information on synthetic feasibility and/or optimal conditions for chemical reactions. The technology disclosed herein can accelerate drug discovery by enabling the screening of a large number of chemical reactions over a relatively brief period.

### SUMMARY OF THE INVENTION

In one aspect, this disclosure provides a method to allow for easy handling and weighing of one or more chemical compounds on a small scale. For example, this disclosure provides a method for improving the flowability of one or more chemical compounds. The method comprises attaching one or more chemical compounds to an outer surface of a bulking agent, such as a glass bead. The chemical compounds take on certain properties (e.g., flowability) of the bulking agent. In certain embodiments, flowability is measured using the Angle of Internal Friction (a lower angle of internal friction indicates higher flowability). In some such embodiments, the coated bulking agent exhibits better flowability than the native chemical compounds.

In one aspect, this disclosure provides a composition comprising a bulking agent and at least one reagent for a chemical reaction. In certain embodiments, at least one reagent for a chemical reaction is coated on the bulking agent. In certain embodiments, at least one reagent is present in amount less than about 20% (w/w) of the bulking agent. In certain embodiments, the composition is prepared by mixing at least one reagent for a chemical reaction with the bulking agent to form a mixture. In some such embodiments, mechanical energy is applied to the mixture by, for example, an acoustic mixer. In certain embodiments, the bulking agent is a bead, such as a glass bead. In certain embodiments, the at least one reagent is selected from the group consisting of a reactant, a transition metal source, a coupling ligand, a base, and combinations thereof.

In another aspect, this disclosure provides a solid substrate and at least one reagent for a chemical reaction attached to an outer surface of the solid substrate. In certain embodiments, at least one reagent is present in amount less than about 20% (w/w) of the solid substrate. In certain embodiments, the composition is prepared by mixing at least one reagent for a chemical reaction with the solid substrate to form a mixture. In some such embodiments, mechanical energy is applied to the mixture by, for example, an acoustic mixer. In certain embodiments, the solid substrate is a bead, such as a glass bead. In certain embodiments, the at least one reagent is selected from the group consisting of a reactant, a transition metal source, a coupling ligand, a base, and combinations thereof.

In yet another aspect, this disclosure provides a solid reagent dispensing system and a method for making the solid reagent dispensing system. In certain embodiments, the method for making the solid reagent dispensing system comprises applying mechanical energy to a mixture comprising at least one reagent and a bulking agent. In some such embodiments, the mechanical energy is applied by an acoustic mixer. In certain embodiments, the solid reagent dispensing system comprises a bulking agent coated with at least one reagent. In some such embodiments, the bulking agent is a bead, such as a glass bead. In some such embodiments, the at least one reagent is selected from the group consisting of a reactant, a transition metal source, a coupling ligand, a base, and combinations thereof.

In still another aspect, this disclosure provides a method for mixing a reagent and a bulking agent. In certain embodiments, the method includes dispensing a quantity of a reagent into a mixing vessel. The reagent may be dispensed, for example, via a solid dispensing unit. In certain embodiments, the method includes dispensing a quantity of a bulking agent into the mixing vessel. The bulking agent may be dispensed, for example, via a solid dispensing unit. In certain embodiments, the method further includes identifying, via a processor, a quantity of bulking agent for dispensing based upon the quantity of the reagent and dispensing, via the solid dispensing unit, the quantity of the glass beads into the mixing vessel. In certain embodiments, the method includes mixing, via an acoustic mixer, the reagent and the bulking agent. In some such embodiments, the method includes mixing, via an acoustic mixer, the reagent and a bead, such as a glass bead, to form a reagent-coated bead. The reagent-coated bead may be then used, for example, in high-throughput screening of a plurality of chemical reactions.

In still another aspect, this disclosure provides a screening method using the compositions or solid reagent dispensing systems disclosed herein to screen chemical reactions. In certain embodiments, the screening method is a high throughput screening method. In certain embodiments, the method comprises dispensing the composition or solid reagent dispensing system into a reaction vessel. In some such embodiments, the dispensing step is automated. In some such embodiments, the dispensing step is performed by a solid dispensing unit. In some such embodiments, the solid dispensing unit includes a controller to identify the quantity of the composition or solid reagent dispensing system to dispense into the reaction vessel. In certain embodiments, the method further comprises dispensing one or more additional solid or liquid reagents into the reaction vessel. In certain embodiments, the method comprises dispensing a plurality of compositions or solid reagent dispensing systems into a plurality of reaction vessels in order to perform a plurality of chemical reactions in parallel. In some such embodiments, the chemical reactions are micro-scale reactions. In some such embodiments, the method comprises performing at least 5, at least 10, at least 15, at least 20, at least 25, at least 50, or at least 100 chemical reactions in parallel. In certain embodiments, the method comprises screening chemical reactions to identify a suitable reagent or combination of reagents for subsequent scale up runs, such as production runs.

In still another aspect, this disclosure provides a high throughput method for screening a plurality of chemical reactions. In certain embodiments, the plurality of chemical reactions is run in parallel. In certain embodiments, one or more reagents common to each reaction of the plurality of reactions is dispensed on a micro-scale, for example, from about 0.1 mg to about 1 mg. In certain embodiments, one or more reagents common to each reaction of the plurality of reactions is dispensed as a solid. In some such embodiments, the reagent is dispensed with a bulking agent or solid substrate. In some such embodiments, the reagent is coated on the bulking agent. In some such embodiments, the reagent is attached to an outer surface of the solid substrate. In some such embodiments, the dispensing step is automated. In some such embodiments, the dispensing step is performed by a solid dispensing unit. In some such embodiments, the solid dispensing unit includes a controller to identify the quantity of the reagent system to dispense into the reaction vessel.

These and other objects of the invention are described in the following paragraphs. These objects should not be deemed to narrow the scope of the invention.

### BRIEF DESCRIPTION OF THE DRAWINGS

For a better understanding of the invention, reference may be made to embodiments shown in the following drawings.

FIG. 1 is a flowchart for mixing reagents and bulking agents in accordance with an exemplary embodiment disclosed herein.

FIG. 2 is a flowchart for dispensing reagent-coated bulking agents to a reaction vessel (e.g., for high-throughput screening) in accordance with an exemplary embodiment disclosed herein.

FIGS. 3A and 3B show results from a series of reactions using reagent-coated beads for evaluating a test library.

FIGS. 4A, 4B and 4C show results from a series of reactions using reagent-coated beads for reaction condition screening.

FIG. 5 is a plot showing the intensity (area under the curve) of UV absorbance for each reagent (catalyst and ligand) at various concentrations on a mixed reagent-coated bead containing both catalyst and ligand.

FIG. 6 shows LCMS analysis of a nanomole scale reaction using a single mixed reagent-coated bead containing a catalyst, a ligand, and a base.

FIG. 7 shows LCMS analysis of a reaction using a combination-catalyst-coated bead and a combination-base-coated bead.

### DETAILED DESCRIPTION OF THE INVENTION

This detailed description is intended only to acquaint others skilled in the art with the present invention, its principles, and its practical application so that others skilled in the art may adapt and apply the invention in its numerous forms, as they may be best suited to the requirements of a particular use. This description and its specific examples are intended for purposes of illustration only. This invention, therefore, is not limited to the embodiments described in this patent application, and may be variously modified.

In various aspects, this disclosure provides an efficient screening method for chemical reactions. In certain embodiments, the screening method is a high throughput screening method. In certain embodiments, compositions, systems, and methods disclosed herein reduce an amount of reagent utilized in preparing for high-throughput screening by utilizing an acoustic mixer to coat a bulking agent with a reagent. By reducing the amount of reagent utilized in preparing for the high-throughput screening, a more manageable-sized library of reagents is produced, thereby reducing the time and resources devoted to the screening task. Moreover, in certain embodiments, an automated solid dispensing unit dispenses the reagent-coated bulking agent into a reaction vessel to further reduce preparation time for the high-throughput screening.

### A. DEFINITIONS

As used herein, an “acoustic mixer” refers to a device (e.g., a Resodyn® acoustic mixer) that emits low-frequency, high-amplitude sound waves to cause material within a container to vibrate and mix together.

As used herein, a “bulking agent” refers to a solid material (e.g., a glass bead, sand, etc.) used to dilute another solid material (e.g., a reagent) in order to increase the total weight/volume of the solid materials, thereby improving handling (e.g., dispensing).

As used herein, “coat” or “coated” refers a reagent molecule attached to an outer surface of a solid material, such as a bulking agent. The term “coat” or “coated” encompasses a single reagent molecule attached to an outer surface of the bulking agent as well as a plurality of reagent molecules attached to an outer surface of the bulking agent, including where the plurality of reagent molecules partially, substantially, or completely cover the outer surface of the bulking agent.

As used herein, a “reagent” refers to a substance and/or compound that is utilized in a chemical reaction. The term “reagent” includes reactants as well as substances and/or compounds that facilitate the chemical reaction, such as catalysts, ligands, bases, and the like.

As used herein, a “solid dispensing unit” refers to a device that is capable of dispensing solid material (e.g., powders, beads, etc.) into a container (e.g., a mixing vessel or a reaction vessel). Example solid dispensing units include automated solid dispensing units (e.g., a SWAVE Solid Dispensing Unit dispensing unit manufactured by Chemspeed® Technologies) that gravimetrically dispense a predetermined amount of solid material from corresponding cartridges and/or other containers, such as a solid dispensing bottle.

### B. SOLID REAGENT DISPENSING SYSTEMS

In at least one aspect, this disclosure provides a method of mixing a reagent for chemical synthesis and a bulking agent. In certain embodiments, the method comprises combining the reagent and the bulking agent to form a mixture. In certain embodiments, the method comprises applying mechanical energy to the mixture. In certain embodiments, the mechanical energy is applied by a resonance acoustic mixer. In certain embodiments, the reagent and the bulking agent are dispensed into a mixing vessel. In certain embodiments, a quantity of a reagent and a quantity of bulking agent are automatically dispensed into the mixing vessel. As used herein, a “mixing vessel” refers to a container in which two or more materials (e.g., a reagent and a bulking agent) are to be mixed, preferably mechanically mixed, together.

In certain embodiments, the reagent for chemical synthesis is a reactant, a transition metal source, a coupling ligand, a base, or a combination thereof. In certain embodiments, the reagent is a source of a transition metal. In some such embodiments, the transition metal is palladium, copper, nickel, or a combination thereof. In certain embodiments, the reagent is a coupling ligand. In some such embodiments, the coupling ligand is a phosphine ligand. In certain embodiments, the reagent is a metal-ligand complex. In some such embodiments, the metal-ligand complex is Pd(dppf)Cl₂, Pd(dppe)Cl₂, PdCl₂(PPh₃)₂, PdCl₂(PCy₃)₂, Pd(t-Bu₃P)₂, RuPhos Pd G2, BrettPhos Pd G3, JackiePhos Pd G3, XantPhos Pd G3, or NiCl₂(PCy₃)₂.

In certain embodiments, the bulking agent is sand or a bead, such as a glass bead, a latex bead, or a polystyrene bead. In certain embodiments, the bulking agent is a solid substrate, such as a bead. In certain embodiments, the solid substrate is a bead, such as a glass bead, a plastic bead, or a latex bead. In certain embodiments, the diameter of the bead is from about 100 microns to about 1200 microns, preferably from about 150 microns to about 500 microns, and more preferably from about 200 microns to about 350 microns. In certain embodiments, the diameter of the bead is from about 210 microns to about 300 microns. In certain embodiments, the bead is a glass bead having a diameter from about 210 microns to about 300 microns.

In certain embodiments, the mixing is mechanical mixing. Mechanical mixing may be performed in an acoustic mixer, such as a Resonant Acoustic® Mixer (Resodyn). Mechanical mixing works on the application of low frequency, high intensity acoustic field facilitating the movement of solids to induce mixing.

In certain embodiments, an acoustic mixer is utilized to mix the reagent and the bulking agent within the mixing vessel. For example, the acoustic mixer applies mechanical energy to the mixing vessel containing the reagent and the bulking agent to form a reagent-coated bulking agent (e.g., a reagent-coated bead). In some such embodiments, a controller controls operation of the acoustic mixer. For example, the controller may send an instruction and/or a signal to the acoustic mixer to activate mixing of the reagent and the bulking agent, to set the mixing intensity, and/or to continue mixing for a predetermined duration of mixing.

In certain embodiments, the acoustic mixer emits mechanical energy such that the contents of the vessel (e.g., the reagent and the bulking agent) vibrate. Thus, in certain embodiments, the acoustic mixer emits mechanical energy to form reagent-coated bulking agents (e.g., reagent-coated beads) by causing the reagent and the bulking agent to vibrate (e.g., at resonance).

In certain embodiments, the acoustic mixer distributes the reagent substantially evenly on the outer surface of the bulking agent without the reagent sticking or clumping during the mixing process. Such even distribution on the outer surface of the bulking agent allows for the reagent to be weighed out accurately and easily because the reagent-coated bulking agent (e.g., reagent-coated beads) has certain properties of the bulking agent (e.g., bead).

In certain embodiments, the acoustic mixer operates at mechanical resonance. In certain embodiments, the acoustic mixer operates between about 50 Hz and about 70 Hz, such as about 60 to about 61 Hz. In certain embodiments, the mixing intensity is set at from about 0% to about 100%. The intensity of mixing correlates with the accelerative force applied to the mixing vessel and a fortiori, the mixture within the mixing vessel. In certain embodiments, the acceleration value is from about 0 g to about 100 g. For example, the acceleration value may be from about 5 g to about 100 g, from about 10 g to about 90 g, from about 20 g to about 80 g, from about 30 g to about 70 g, or from about 40 g to about 60 g. As another example, the acceleration value may be from about 5 g to about 50 g, from about 10 g to about 45 g, from about 15 g to about 40 g, from about 20 g to about 35 g, or from about 25 g to about 30 g. In certain embodiments, the acceleration value is about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, or about 60 g. The acceleration value may be determined by an accelerometer mounted on or near the mixing vessel.

In certain embodiments, the mechanical mixing occurs for a time period from about 10 seconds to about 120 minutes. For example, the time period may be from about 1 minute to about 60 minutes, about 5 minutes to about 45 minutes, or about 10 minutes to about 30 minutes. In certain embodiments, the time period is about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, or about 60 minutes. In certain embodiments, the time period is about 15 minutes. In certain embodiments, the length of the time period depends upon the type of chemical compound. For example, certain chemicals, such as bases, benefit from time periods longer than 15 minutes, such as about 30 minutes or about 60 minutes. In certain embodiments, the time period is divided in to one or more sub-periods.

In certain embodiments, the mechanical mixing occurs for a time period of at least 10 seconds. For example, the time period may be at least 10 seconds, at least 30 seconds, at least 1 minute, at least 2 minutes, at least 3 minutes, at least 4 minutes, at least 5 minutes, at least 6 minutes, at least 7 minutes, at least 8 minutes, at least 9 minutes, at least 10 minutes, at least 11 minutes, at least 12 minutes, at least 13 minutes, at least 14 minutes, at least 15 minutes, at least 16 minutes, at least 17 minutes, at least 18 minutes, at least 19 minutes, at least 20 minutes, at least 21 minutes, at least 22 minutes, at least 23 minutes, at least 24 minutes, at least 25 minutes, at least 26 minutes, at least 27 minutes, at least 28 minutes, at least 29 minutes, or at least 30 minutes.

In certain embodiments, a solid reagent and a bulking agent (e.g., glass beads, sand, etc.) are combined in a mixing vessel and mechanical energy is applied to the vessel via an acoustic mixer. In some such embodiments, the mixing vessel is a 20-milliliter vessel and/or any other vessel capable of containing the solid reagent and the bulking agent during mechanical mixing. In some such embodiments, a solid reagent and a bulking agent are manually added to the mixing vessel. For example, an operator may weigh out an appropriate amount of reagent and bulking agent and then add the amount of reagent and amount of bulking agent to the mixing vessel. The operator may then place the mixing vessel into the acoustic mixer. In other such embodiments, the solid reagent and the bulking agent are automatically added to the mixing vessel. In certain embodiments, the solid reagent is added to the mixing vessel first and the bulking agent is subsequently added to the mixing vessel such that the bulking agent (e.g., glass beads) lays over the solid reagent when mixing is initiated.

In certain embodiments, the solid reagent and/or the bulking agent are added in bulk to the mixing vessel. For example, when the bulking agent is a glass bead, about 5, about 10, about 15, about 20, about 25, or about 30 grams of glass beads may be added to the mixing vessel. Correspondingly, about 250, about 500, about 750, about 1000, about 1250, or about 1500 milligrams of reagent may be added to the mixing vessel (e.g., to create 5% (w/w) reagent-coated beads).

In certain embodiments, the solid reagent is an air-sensitive material. In some such embodiments, the air-sensitive solid reagent is weighed out, added to the mixing vessel, and/or subsequently stored in a glovebox.

In certain embodiments, a solid reagent is mechanically processed prior to being added to the mixing vessel. For example, a base or ligand may be milled to a fine powder (e.g., <300 μm) prior to being added to the mixing vessel. In some such embodiments, the milling process includes adding a milling ball, such as yttrium stabilized zirconium ball, to the solid reagent and mixing the solid reagent and the milling ball. The milled material can then be coated on the bulking agent.

In certain embodiments, a reagent-coated bead prepared by the above method is dispensed into a vial. In some such embodiments, the vial is a reaction vessel. In some such embodiments, the reagent-coated bead is stored under vacuum or nitrogen until use.

In at least one aspect, this disclosure provides a chemical-coated bead, such as a chemical-coated glass bead. The chemical-coated bead may be for use in a chemical reaction. In certain embodiments, a plurality of chemical-coated beads may be for use in a plurality of chemical reactions, such as in high throughput screening of a plurality of chemical reactions. In certain embodiments, the chemical-coated bead has at least chemical attached to its outer surface, such as a reactant, a transition metal source, a coupling ligand, or an inorganic base. In certain embodiments, the chemical-coated bead has a plurality of chemicals attached to its surface. In some such embodiments, the plurality of chemicals comprises identical molecules. In other such embodiments, the plurality of chemicals comprises different molecules. In certain embodiments, the chemical-coated bead is prepared by applying mechanical energy to a mixture comprising a chemical and a bead. In certain embodiments, the chemical-coated bead is prepared by mixing a chemical and a bead in an acoustic mixer.

In at least one aspect, this disclosure provides a reagent-coated bead, such as a reagent-coated glass bead. The reagent-coated bead may be for use in a chemical reaction. In certain embodiments, a plurality of reagent-coated beads may be for use in a plurality of chemical reactions, such as in high throughput screening of a plurality of chemical reactions. In certain embodiments, the reagent-coated bead has at least one reagent molecule attached to its outer surface. In certain embodiments, the reagent-coated bead has a plurality of reagent molecules attached to its surface. In some such embodiments, the plurality of reagent molecules comprises identical reagent molecules. In other such embodiments, the plurality of reagent molecules comprises different reagent molecules. For example, the reagent-coated bead may be a bead comprising both a catalyst and a ligand. As another example, the reagent-coated bead may be a bead comprising a catalyst, a ligand, and a base. In certain embodiments, the reagent-coated bead is prepared by applying mechanical energy to a mixture comprising a reagent and a bead. In certain embodiments, the reagent-coated bead is prepared by mixing a reagent and a bead in an acoustic mixer.

### C. SCREENING CHEMICAL REACTIONS

In at least one aspect, this disclosure provides a method for screening chemical reactions. In certain embodiments, the method is a high throughput method. In certain embodiments, the method is a micro-scale method.

In certain embodiments, the method comprises adding a solid reagent dispensing system, such as one or more reagent-coated beads, to a reaction vessel. In certain embodiments, the reaction vessel is a well of a microtiter plate. For example, the method may be performed using an “automation-friendly” microtiter plate. In some such embodiments, the microtiter plate has a 96-well, a 384-well, or a 1536-well format.

As noted above, a reagent-coated bead may be a bead comprising a single type of reagent (e.g., a catalyst, a ligand, or a base). Alternatively, a reagent-coated bead may be a bead comprising a combination of reagents, such as a catalyst and a ligand or a catalyst, a ligand, and a base.

In certain embodiments, a reagent-coated bead is manually added to a reaction vessel. For example, an operator may dispense an appropriate amount of reagent-coated beads to the reaction vessel. In some such embodiments, a single reagent-coated bead is dispensed to the reaction vessel (e.g., for carrying out nanomole scale reactions). In other such embodiments, a plurality of reagent-coated beads are dispensed to the reaction vessel.

In certain embodiments, a reagent-coated bead is automatically added to a reaction vessel. In certain embodiments, a solid dispensing unit automatically dispenses a quantity of reagent-coated beads into the reaction vessel. In certain embodiments, the method includes identifying, via a processor, a quantity of reagent-coated beads for dispensing based upon the desired quantity of the reagent and dispensing, via the solid dispensing unit, the identified quantity of the reagent-coated beads into the reaction vessel. Thus, in certain embodiments, the processor identifies the quantity of reagent-coated beads to be dispensed, instructs the solid dispensing unit to dispense the quantity of the reagent-coated beads. In certain embodiments, the quantity of reagent-coated beads to be dispensed into the reaction vessel is selected by a user. In some such embodiments, a single reagent-coated bead is dispensed to the reaction vessel (e.g., for carrying out nanomole scale reactions). In other such embodiments, a plurality of reagent-coated beads are dispensed to the reaction vessel.

In certain embodiments, a reagent-coated bead is added to a reaction vessel using a measuring scoop. In some such embodiments, an operator uses the measuring scoop to manually dispense the reagent-coated beads into a reaction vessel. In some such embodiments, a controller controls operation of the measuring scoop (e.g., by sending an instruction and/or a signal) for transferring and/or dispensing the reagent-coated beads into a reaction vessel. In some such embodiments, a plurality of reagent-coated beads are dispensed to the reaction vessel (e.g., for carrying out millimole scale reactions).

In certain embodiments, the method further comprises adding one or more additional solid or liquid reagents to the reaction vessel. Such additional solid or liquid reagents may be added manually or automatically.

In certain embodiments, the method comprises automatically dispensing reagent-coated beads into reaction vessels. The reagent-coated beads may provide a single reagent (e.g., beads having a single type of reagent coated on their surface). Alternatively, the reagent-coated beads may provide more than one reagent (e.g., beads having more than one type of reagent coated on their surface). In some such embodiments, a plurality of types of reagent-coated beads is added to the reaction vessel to provide a plurality of reagents. Any reagents that have not been provided via reagent-coated beads (e.g., liquid reagents or additional solid reagents) may then be added to the reaction vessel. For example, in certain embodiments, additional solid reagents are dissolved in a reaction solvent(s) (e.g., about 0.2 mL/vessel) and added to the reaction vessels containing the reagent-coated beads. In certain embodiments, the reaction vessels are incubated for a time and under conditions sufficient for the desired chemical reaction to occur. For example, the reaction vessels may be placed on a heater/shaker and heated to the desired temperature (varies by reaction type) for the desired amount of time (e.g., 16 h).

In operation, a solid dispensing unit dispenses a quantity of reagent-coated beads in to reaction vessels. The quantity may be based on the weight and/or number of reagent-coated beads. For example, the solid dispensing unit dispenses the reagent-coated beads from a cartridge into a reaction vessel. In certain embodiments, the solid dispensing operates to actuate to a cartridge holder, retrieve a first cartridge that contains a first reagent-coated bead from a cartridge holder, actuate to a position above a first reaction vessel, and/or dispense a quantity of the first reagent-coated bead from the first cartridge into the first reaction vessel. In certain embodiments, the solid dispensing unit operates to further retrieve a second cartridge that contains a second reagent-coated bead, return to the position above the first reaction vessel, and dispense a quantity of the second reagent-coated bead from the second cartridge into the first reaction vessel. In certain embodiments, the solid dispensing unit operates to further retrieve a further cartridge that contains a further reagent-coated bead, actuate to the position above a further reaction vessel, and dispense a quantity of the further reagent-coated bead from the further cartridge into the further reaction vessel.

In at least one aspect, the disclosure provides a method for preparing a library of solid reagent dispensing systems, such as a library of reagent-coated beads. In certain embodiments, the library of solid reagent dispensing systems is for use in a high-throughput screening method. The library of solid reagent dispensing systems comprises a plurality of different reagents. In certain embodiments, each of the plurality of reagents is prepared by applying mechanical energy to a mixing vessel containing the reagent and a bulking agent. For example, in some such embodiments, each of the plurality of reagents is prepared by applying mechanical energy to a mixing vessel containing the reagent and a glass bead. In certain embodiments, an acoustic mixer is configured to mix one mixing vessel or a plurality of mixing vessels (e.g., a first mixing vessel, a second mixing vessel, etc.) simultaneously.

In certain embodiments, a library of reagent-coated beads is provided. One or more reaction conditions can be selected from the library of reagent-coated beads. For example, where the library comprises a first reagent-coated bead coated with a transition metal source and a second reagent-coated bead coated with a ligand, the first reagent-coated bead and the second reagent-coated bead may be combined in a reaction vessel to provide a reaction condition. As another example, where the library comprises a first reagent-coated bead coated with a transition metal source and a second reagent-coated bead coated with a ligand and a third reagent-coated bead coated with a base, such as an inorganic base, the first reagent-coated bead and the second reagent-coated bead and the third reagent coated bead may be combined in a reaction vessel to provide a reaction condition. Alternatively, where the library comprises a single type of reagent-coated bead coated with two or more reagents, such as a transition metal source and a ligand (or a metal-ligand complex), the single type of reagent-coated bead may be added to the reaction vessel to provide a reaction condition.

In some such embodiments, a plurality of reagents is dispensed into a reaction vessel. Each of the reagents may be attached to a bead. The plurality of reagents may be attached to the same bead or separate beads. Thus, the reaction vessel may contain a first reagent-coated bead comprising a first reagent for chemical synthesis and a second reagent-coated bead comprising a second reagent for chemical synthesis. In some such embodiments, the reaction vessel further comprises a third reagent-coated bead comprising a third reagent for chemical synthesis. The combination of the first reagent-coated bead, the second reagent-coated bead, and, optionally, further reagent-coated beads, wherein each bead comprises a different reagent, is referred to herein as a “panel” of reagent coated beads.

In certain embodiments, a panel of reagent-coated beads is selected from the library to provide a transition metal source, a coupling ligand, and/or a base. In some such embodiments, the transition metal source and the coupling ligand are provided as a metal-ligand complex.

For example, in some such embodiments, the panel of reagent-coated beads is selected to provide certain reaction conditions, such as conditions for a Suzuki coupling reaction. Exemplary conditions for a Suzuki coupling reaction are provided in Table 1.

TABLE 1
Exemplary Suzuki reaction conditions.

| | | |
|---|---|---|
| Transition Metal Source | Coupling Ligand | Base |

| | |
|---|---|
| Pd(dppf)Cl₂ | Cs₂CO₃ |
| Pd(dppf)Cl₂ | K₂CO₃ |
| PdCl₂(PPh₃)₂ | Cs₂CO₃ |
| PdCl₂(PPh₃)₂ | K₂CO₃ |
| PEPPSI-iPr | KOtBu |

| | | |
|---|---|---|
| Pd₂(dba)₃ | PA-Ph | K₃PO₄ |
| Pd₂(dba)₃ | PA-Ph | Cs₂CO₃ |
| Pd₂(dba)₃ | Xphos | K₃PO₄ |
| Pd₂(dba)₃ | Xphos | Cs₂CO₃ |

| | |
|---|---|
| PdCl₂(PCy₃)₂ | K₃PO₄ |
| PdCl₂(PCy₃)₂ | Cs₂CO₃ |

| | | |
|---|---|---|
| Pd(OAc)₂ | S-Phos | K₂CO₃ |
| Pd(OAc)₂ | CataCXium A | Cs₂CO₃ |

| | |
|---|---|
| PdCl₂(dtbpf) | K₂CO₃ |
| Pd(Amphos)Cl₂ | K₂CO₃ |
| Pd(Xantphos)Cl₂ | Cs₂CO₃ |
| 2nd gen RuPhos | Cs₂CO₃ |
| Pd(dppe)Cl₂ | K₃PO₄ |
| Pd(DPEPhos)Cl₂ | K₃PO₄ |

| | | |
|---|---|---|
| Pd₂(dba)₃ | rac-BINAP | K₃PO₄ |
| Pd(OAc)₂ | S-Phos | Cs₂CO₃ |
| Pd(OAc)₂ | S-Phos | K₃PO₄ |

| | |
|---|---|
| Pd(DPEPhos)Cl₂ | Cs₂CO₃ |
| PdCl₂(dtbpf) | K₃PO₄ |
| PdCl₂(dtbpf) | Cs₂CO₃ |
| Pd(dppe)Cl₂ | Cs₂CO₃ |
| Pd(dppe)Cl₂ | K₂CO₃ |
| Pd(Amphos)Cl₂ | Cs₂CO₃ |
| Pd(Xantphos)Cl₂ | K₃PO₄ |

| | | |
|---|---|---|
| Pd₂(dba)₃ | rac-BINAP | Cs₂CO₃ |

| | |
|---|---|
| Xphos precat G2 | K₃PO₄ |

| | | |
|---|---|---|
| Pd(OAc)₂ | RuPhos | K₂CO₃ |

| | |
|---|---|
| PdCl₂(PCy₃)₂ | KOtBu |

| | | |
|---|---|---|
| Pd(OAc)₂ | CataCXiumA | K₃PO₄ |
| [Pd(cinnamyl)Cl]₂ | Ipr | NaOtBu |
| CuI | N-(Me)₂-PhenylP(Ph)₂ | CsF |
| CuI | N-(Me)₂-PhenylP(tBu)₂ | CsF |
| CuI | | LiOtBu |
| Cu powder | | K₂CO₃ |
| CuCl | XantPhos | NaOtBu |
| NiCl₂-glyme | trans-1,2-Cy-(NHMe)₂ | KOtBu |

| | |
|---|---|
| NiCl₂(PCy₃)₂ | K₃PO₄ |

As another example, in some such embodiments, the panel of reagent-coated beads is selected to provide reaction conditions for a Buchwald cross-coupling reaction. Exemplary conditions for a Buchwald cross-coupling reaction are provided in Table 2.

TABLE 2
Exemplary Buchwald cross-coupling reaction conditions.

| | | |
|---|---|---|
| Transition Metal Source | Coupling Ligand | Base |

| | |
|---|---|
| BrettPhos precat G3 | LiHMDS |

| | | |
|---|---|---|
| BrettPhos precat G3 | BrettPhos | NaOtBu |
| BrettPhos precat G3 | BrettPhos | Cs₂CO₃ |
| BrettPhos precat G3 | RuPhos | K₃PO₄ |
| BrettPhos precat G3 | Xphos | NaOtBu |

| | |
|---|---|
| RuPhos precat G2 | NaOtBu |
| RuPhos precat G2 | LiHMDS |
| PEPPSI-iPr | KOtBu |
| PEPPSI-iPent | KOtBu |
| tBuXPhos-Pd-G3 | NaOtBu |

| | | |
|---|---|---|
| Pd₂(dba)₃ | Me₄tBuXPhos | LiHMDS |
| Pd₂(dba)₃ | Me₄tBuXPhos | K₃PO₄ |
| Pd₂(dba)₃ | Xphos | Cs₂CO₃ |
| Pd₂(dba)₃ | XPhos | LiHMDS |
| Pd₂(dba)₃ | RuPhos | Cs₂CO₃ |
| Pd₂(dba)₃ | RuPhos | NaOtBu |
| Pd₂(dba)₃ | BrettPhos | NaOtBu |
| Pd₂(dba)₃ | BrettPhos | K₃PO₄ |
| Pd₂(dba)₃ | XantPhos | Cs₂CO₃ |
| Pd₂(dba)₃ | tBuXPhos | Cs₂CO₃ |
| Pd₂(dba)₃ | rac-BINAP | NaOtBu |
| Pd₂(dba)₃ | Sphos | NaOtBu |
| Pd₂(dba)₃ | tBuDavePhos | NaOtBu |
| Pd(OAc)₂ | XantPhos | Cs₂CO₃ |
| BrettPhos precat G3 | RuPhos | NaOtBu |

| | |
|---|---|
| BrettPhos precat G3 | Cs₂CO₃ |
| BrettPhos precat G3 | K₂CO₃ |
| BrettPhos precat G3 | LiHMDS |
| BrettPhos precat G3 | Cs₂CO₃ |

| | | |
|---|---|---|
| RuPhos precat G2 | Me₄tBuXPhos | NaOtBu |
| RuPhos precat G2 | Me₄tBuXPhos | Cs₂CO₃ |
| tBuXPhos-Pd-G3 | Xphos | K₂CO₃ |
| tBuXPhos-Pd-G3 | Xphos | NaOtBu |
| Pd₂(dba)₃ | RuPhos | LiHMDS |
| Pd₂(dba)₃ | RuPhos | K₃PO₄ |
| Pd₂(dba)₃ | BrettPhos | LiHMDS |
| Pd₂(dba)₃ | BrettPhos | Cs₂CO₃ |
| Pd₂(dba)₃ | XantPhos | NaOtBu |
| Pd₂(dba)₃ | XantPhos | LiHMDS |
| Pd₂(dba)₃ | XantPhos | K₂CO₃ |
| Pd₂(dba)₃ | tBuXPhos | NaOtBu |
| Pd₂(dba)₃ | tBuXPhos | LiHMDS |
| Pd₂(dba)₃ | rac-BINAP | K₃PO₄ |
| Pd₂(dba)₃ | rac-BINAP | Cs₂CO₃ |
| Pd₂(dba)₃ | rac-BINAP | LiHMDS |
| Pd₂(dba)₃ | XantPhos | K₃PO₄ |
| Pd₂(dba)₃ | XantPhos | NaOtBu |
| Pd₂(dba)₃ | tBuDavePhos | NaOtBu |
| Pd(OAc)₂ | Xphos | K₂CO₃ |

| | |
|---|---|
| Josiphos precat G3 | NaOtBu |
| Josiphos precat G3 | LiHMDS |
| JackiePhos precat G3 | NaOtBu |
| tBuBrettPhos precat G3 | NaOtBu |

| | | |
|---|---|---|
| Pd₂(dba)₃ | tBuPCy₂-HBF₄ | K₃PO₄ |
| Pd₂(dba)₃ | AmPhos | NaOtBu |
| Pd₂(dba)₃ | ditBuPF | NaOtBu |
| Ni(PPh₃)₂(1-naph)Cl | IPr—HCl | NaOtBu |
| Ni(PPh₃)₂(o-tolyl)Cl | IPr—HCl | NaOtBu |
| [Pd(cinnamyl)Cl]₂ | (N-diMe-Ph)P(tBu)₂ | NaOtBu |
| CuCl | TMHD | Cs₂CO₃ |
| CuI | L-proline | K₃PO₄ |

| | |
|---|---|
| DPPF-Pd-G3 | Cs₂CO₃ |

| | | |
|---|---|---|
| Xphos Precat G2 | Xphos | K₃PO₄ |

The abbreviations for transition metal sources, coupling ligands, and/or metal-ligand complexes in Table 1 and Table 2 are as follows:
Pd(dppf)Cl₂: [1,1′-Bis(diphenylphosphino)ferrocene]dichloropalladium(II)
PdCl₂(PPh₃)₂: Bis(triphenylphosphine)palladium(II) dichloride
PEPPSI-iPr: [1,3-Bis(2,6-Diisopropylphenyl)imidazol-2-ylidene](3-chloropyridyl)palladium(II) dichloride
PEPPSI-iPent: [1,3-Bis(2,6-Di-3-pentylphenyl)imidazol-2-ylidene](3-chloropyridyl)palladium(II) dichloride
Pd₂(dba)₃: bis(dibenzylideneacetone) palladium(0)
PdCl₂(PCy₃)₂: Dichlorobis(tricyclohexylphosphine)palladium(II)
Pd(OAc)₂: Palladium(II) acetate
PdCl₂(dtbpf): [1,1′-Bi s(di-tert-butylphosphino)ferrocene]dichloropalladium(II)
Pd(Amphos)Cl₂: Bis(di-tert-butyl(4-dimethylaminophenyl)phosphine)dichloropalladium(II)
Pd(Xantphos)Cl₂: Dichloro[9,9-dimethyl-4,5-bis(diphenylphosphino)xanthene]palladium(II)
2nd gen RuPhos: Chloro(2-dicyclohexylphosphino-2′,6′-diisopropoxy-1,1′-biphenyl)[2-(2′-amino-1,1′-biphenyl)]palladium(II)
Pd(dppe)Cl₂: [1,2-Bi s(diphenylphosphino)ethane]dichloropalladium(II)
Pd(DPEPhos)Cl₂: Dichloro[bis(2-(diphenylphosphino)phenyl)ether]palladium(II)
Xphos precat G2: Chloro[(4,5-bis(diphenylphosphino)-9,9-dimethylxanthene)-2-(2′-amino-1,1′-biphenyl)]palladium(II)
[Pd(cinnamyl)Cl]₂: Palladium(n-cinnamyl) chloride dimer
Ipr: 1,3-Bis(2,6-diisopropylphenyl)-1,3-dihydro-2H-imidazol-2-ylidene
NiCl₂-glyme: Nickel(II) chloride ethylene glycol dimethyl ether complex
NiCl₂(PCy₃)₂: Bis(tricyclohexylphosphine)nickel(II) dichloride
PA-Ph: 1,3,5,7-Tetramethyl-6-phenyl-2,4,8-trioxa-6-phosphaadamantane
S-Phos: 2-Dicyclohexylphosphino-2′,6′-dimethoxybiphenyl
CataCXium A: Di(1-adamantyl)-n-butylphosphine
rac-BINAP: (±)-2,2′-Bis(diphenylphosphino)-1,1′-binaphthalene
trans-1,2-Cy-(NHMe)₂: trans-N,N′-Dimethylcyclohexane-1,2-diamine
XantPhos: 4,5-Bis(diphenylphosphino)-9,9-dimethylxanthene
RuPhos: 2-Dicyclohexylphosphino-2′,6′-diisopropoxybiphenyl
BrettPhos: 2-(Dicyclohexylphosphino)3,6-dimethoxy-2′,4′,6′-triisopropyl-1,1′-biphenyl
Xphos: 2-Dicyclohexylphosphino-2′,4′,6′-triisopropylbiphenyl
Me₄tBuXPhos: 2-Di-tert-butylphosphino-3,4,5,6-tetramethyl-2′,4′,6′-triisopropyl-1,1′-biphenyl
tBuXPhos: 2-Di-tent-butylphosphino-2′,4′,6′-triisopropylbiphenyl
tBuDavePhos: 2′-(Di-tent-butylphosphino)-N,N-dimethylbiphenyl-2-amine
N-(Me)₂-PhenylP(Ph)₂ (Ph Dave Phos): 2′-(Diphenylphosphino)-N,N′-dimethyl-(1,1′-biphenyl)-2-amine, 2-Diphenylphosphino-2′-(N,N-dimethylamino)biphenyl
BrettPhos precat G3: [(2-Di-cyclohexylphosphino-3,6-dimethoxy-2′,4′,6′-triisopropyl-1,1′-biphenyl)-2-(2′-amino-1,1′-biphenyl)]palladium(II) methanesulfonate
tBuXPhos-Pd-G3: [(2-Di-tert-butylphosphino-2′,4′,6′-triisopropyl-1,1′-biphenyl)-2-(2′-amino-1,1′-biphenyl)] palladium(II) methanesulfonate
Josiphos precat G3: {(R)-1-[(Sp)-2-(Dicyclohexylphosphino)ferrocenyl]ethyldi-tert-butylphosphine}[2-(2′-amino-1,1′-biphenyl)]palladium(II) methanesulfonate
JackiePhos precat G3: [(2-{Bis[3,5-bis(trifluoromethyl)phenyl]phosphine}-3,6-dimethoxy-2′,4′,6′-triisopropyl-1,1′-biphenyl)-2-(2′-amino-1,1′-biphenyl)]palladium(II) methanesulfonate
tBuBrettPhos precat G3: [(2-Di-tert-butylphosphino-3,6-dimethoxy-2′,4′,6′-triisopropyl-1,1′-biphenyl)-2-(2′-amino-1,1′-biphenyl)]palladium(II) methanesulfonate
Ni(PPh₃)₂(1-naph)Cl: Chloro(1-naphthyl)bis(triphenylphosphine)nickel(II)
Ni(PPh₃)₂(o-tolyl)Cl: Chloro(2-methylphenyl)bis(triphenylphosphine)nickel(II)
DPPF-Pd-G3: Methanesulfonato 1,1 -ferrocenediyl-bis(diphenylphosphino) (2′-amino-1,1′-biphenyl-2-yl) palladium(II)
Xphos Precat G2: Chloro(2-dicyclohexylphosphino-2′,4′,6′-triisopropyl-1,1′-biphenyl)[2-(2′-amino-1,1′-biphenyl)]palladium(II)
tBuPCy₂-HBF₄: tert-Butyldicyclohexylphosphonium tetrafluoroborate
AmPhos: (4-(N,N-Dimethylamino)phenyl)di-tert-butyl phosphine
ditBuPF, (DTBPF): 1,1′-Bis(di-tert-butylphosphino)ferrocene
(N-diMe-Ph)P(tBu)₂: [2-(N,N-Dimethylamino)phenyl]di-t-butylphosphine
TMHD: 2,2,6,6-Tetramethyl-3,5-heptanedione

The above embodiments are merely exemplary. Flexible programming allows for additional conditions using the reagents listed above and/or further reagents to provide other reaction conditions as desired. In certain embodiments, the selection of a panel of reagent-coated beads is made automatically by a processor. In certain embodiments, the selection of a panel of reagent-coated beads is made by a user.

In certain embodiments, a reagent-coated bead or a panel of reagent-coated beads is combined with a solvent system in a reaction vessel. The solvent system may comprise, for example, water, tetrahydrofuran (THF), N,N-dimethylformamide (DMF), N,N-dimethylacetamide (DMA), N-methyl-pyrrolidone, dimethyl sulfoxide (DMSO), 1,2-dimethoxy ethane, 1,4-dioxane, acetonitrile, cyclopentyl methyl ether, toluene, benzene, tert-amyl alcohol, tert-butyl alcohol, 2-methyl tetrahydrofuran, ethyl acetate, isopropyl acetate, anisole, trifluorotoluene, or combinations thereof. In some such embodiments, the solvent system comprises dioxane/water, such as 4:1 dioxane/water. In other embodiments, the solvent system comprises toluene/water, such as 10:1 toluene/water. In other embodiments, the solvent system comprises dioxane/DMF, such as 1:1 dioxane/DMF. In still other embodiments, the solvent system comprises tert-butyl alcohol/DMA, such as 4:1 tert-butyl alcohol/DMA.

In certain embodiments, the contents of the reaction vessel are incubated for a time and under conditions sufficient for a desired chemical reaction to occur. Reaction conditions and reaction times can vary depending on the particular reactants employed and substituents present in the reactants used. Unless otherwise specified, solvents, temperatures and other reaction conditions can be readily selected.

In certain embodiments, the contents of the reaction vessel are assessed for evidence of a chemical reaction. The assessment may be made by any available method. For example, the assessment may be by quantitative nuclear magnetic resonance spectroscopy (qNMR) or ultra performance liquid chromatography (UPLC).

Screening large numbers of chemical reactions using a panel of reagents produces a number of ‘active hits’ identifying suitable conditions for further reactions, such as production runs. Thus, high throughput screening can be seen as a quick scan of possible reaction conditions to identify suitable reaction conditions, meaning reagents (including reactants) with poor or no effect can rapidly be dropped from investigation and a portfolio of relevant reagents and combinations of reagents can quickly be built up.

### D. ADDITIONAL EMBODIMENTS

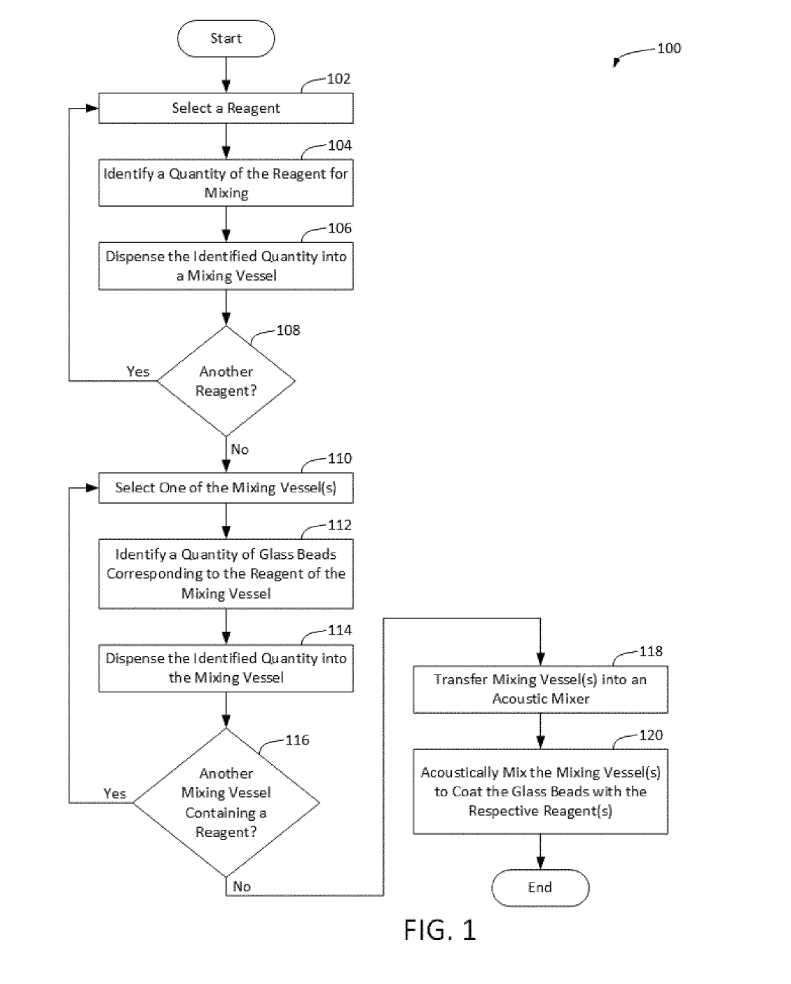

FIG. 1 is a flowchart of an example method 100 to mix reagent(s) and bulking agent(s) (e.g., for high-throughput screening). The flowchart of FIG. 1 is representative of machine readable instructions that are stored in memory (e.g., of a processor) and include one or more programs which, when executed by a processor, cause reagent(s) and bulking agent(s) to be mixed. While the example program is described with reference to the flowchart illustrated in FIG. 1, many other methods of mixing reagent(s) and bulking agent(s) for high-throughput screening may alternatively be used. For example, the order of execution of the blocks may be rearranged, changed, eliminated, and/or combined to perform the method 100.

Initially, at block 102, a processor selects a reagent that is contained within, for example, a cartridge. At block 104, the processor identifies a quantity (e.g., by querying a database) of the reagent that is to be mixed within a mixing vessel. At block 106, a solid dispensing unit, via a processor, dispenses the identified quantity of the reagent into a mixing vessel. For example, the processor instructs the solid dispensing unit to identify and retrieve the appropriate cartridge containing the reagent, actuate to a position above one of the mixing vessel, and dispense the quantity of the reagent into the mixing vessel. At block 108, the processor determines whether there is another reagent to be dispensed into the mixing vessel. In response to the processor determining that there is another reagent to be dispensed, the method 100 returns to block 102. Otherwise, in response to the processor determining that there is not another reagent to be dispensed, the method 100 proceeds to block 110.

At block 110, the processor selects one of the mixing vessels in which a reagent was dispensed. At block 112, the processor identifies a quantity (e.g., by querying a database) of the glass beads and/or other bulking agent that is to be mixed within the selected mixing vessel. For example, the processor determines the quantity of the glass beads that is to be dispensed based upon the quantity of the corresponding reagent that was dispensed. At block 114, a solid dispensing unit, via the processor, dispenses the identified quantity of the glass beads and/or other bulking agent into the selected mixing vessel. For example, the processor instructs the solid dispensing unit to identify and retrieve the appropriate cartridge containing the glass beads and/or other bulking agent, actuate to a position above the selected mixing vessel, and dispense the quantity of the glass beads and/or other bulking agent into the selected mixing vessel. At block 116, the processor determines whether there is another mixing vessel in which a reagent was dispensed. In response to the processor determining that there is another mixing vessel, the method 100 returns to block 110. Otherwise, in response to the processor determining that there is not another mixing vessel, the method 100 proceeds to block 118.

At block 118, the mixing vessel is transferred to an acoustic mixer. For example, the processor sends a signal to instruct that the mixing vessel is to be transferred to the acoustic mixer. At block 120, the acoustic mixer mechanically mixes one or more of the mixing vessels (e.g., simultaneously) to coat the glass beads and/or other bulking agent with the respective reagent(s). For example, the acoustic mixer mechanically mixes material within the mixing vessels by emitting low-frequency, high-amplitude sound waves, causing the reagent(s) to coat the glass beads. In certain embodiments, the processor sends signal(s) to control operation of the acoustic mixer.

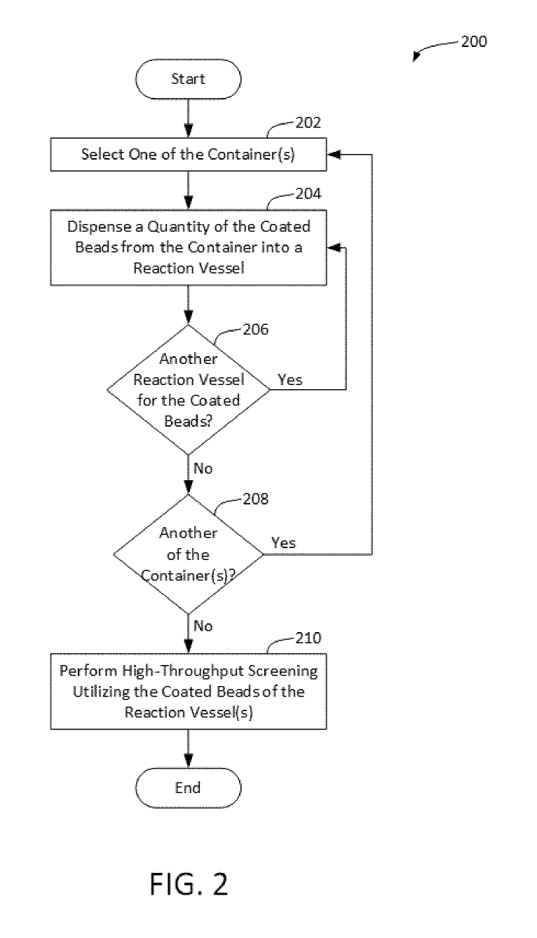

FIG. 2 is a flowchart of an example method 200 to prepare reagent-coated bulking agents for high-throughput screening. The flowchart of FIG. 2 is representative of machine readable instructions that are stored in memory (e.g., of a processor) and include one or more programs which, when executed by a processor, cause reagent-coated bulking agents to be dispensed for high-throughput screening. While the example program is described with reference to the flowchart illustrated in FIG. 2, many other methods of preparing reagent-coated bulking agents for high-throughput screening may alternatively be used. For example, the order of execution of the blocks may be rearranged, changed, eliminated, and/or combined to perform the method 200.

At block 202, a cartridge containing a reagent-coated bead is selected (e.g., by the processor). At block 204, a quantity of the coated beads and/or other coated bulking agent is transferred into a reaction vessel. In certain embodiments, the quantity of reagent-coated beads is transferred using a solid dispensing unit. In some examples, the processor identifies (e.g., by querying a database) the quantity of the reagent-coated beads and/or other coated bulking agent that are to be transferred into the reaction vessel. Additionally or alternatively, the processor sends signal(s) to the solid dispensing unit to cause the quantity of the coated beads and/or other coated bulking agent to be dispensed into a reaction vessel.

At block 206, the method 200 includes determining whether there is another reaction vessel into which the reagent-coated beads and/or other coated bulking agent is to be dispensed. For example, the processor determines whether there is another reaction vessel. In response to determining that there is another reaction vessel, the method 200 returns to block 204. Otherwise, in response to determining that there is not another reaction vessel, the method 200 proceeds to block 208.

At block 208, the method 200 includes determining whether there is another cartridge containing a reagent-coated bead and/or another coated bulking agent (such as ones that were mixed via the acoustic mixer at block 120 of FIG. 1). For example, the processor determines whether there is another cartridge containing a reagent-coated bead. In response to determining that there is another cartridge, the method 200 returns to block 202. Otherwise, in response to determining that there is not another cartridge, the method 200 proceeds to block 210 at which high-throughput screening is performed utilizing the reagent-coated beads and/or other coated bulking agent of one or more of the reaction vessels.

In certain embodiments, operation of the acoustic mixer is controlled by a controller, such as a processor. For example, the processor may send signal(s) to activate and/or stop operation of the acoustic mixer. In certain embodiments, the processor sends an activation signal that includes a duration of mixing (e.g., 15 minutes) to the acoustic mixer. Once the duration of mixing ends, the acoustic mixer stops mixing. In certain embodiments, the processor queries and/or accesses a database to determine the duration of mixing via the acoustic mixer.

In certain embodiments, operation of the solid dispensing unit is controlled by a controller, such as a processor. For example, the processor may be configured to control operation of the solid dispensing unit. In certain embodiments, the processor instructs the solid dispensing unit to dispense a quantity of reagent-coated beads into a reaction vessel. In certain embodiments, the processor queries and/or accesses a database to determine the quantity of the reagent-coated beads to dispense to the reaction vessel.

The processor of the described above may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

In certain embodiments, the memory is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory, the computer readable medium, and/or within the processor 604 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In certain embodiments, an input device enables a user, such as a technician, to provide instructions, commands, and/or data to the processor. Examples of the input device include one or more of a button, a control knob, an instrument panel, a touch screen, a touchpad, a keyboard, a mouse, a speech recognition system, etc.

Exemplary Embodiment 1: A solid substrate comprising an outer surface and at least one reagent for chemical synthesis attached to the outer surface, wherein the reagent for chemical synthesis is attached to the outer surface by an application of mechanical energy to a mixture comprising the reagent for chemical synthesis and the solid substrate.

Exemplary Embodiment 2: The solid substrate of embodiment 1, wherein the solid substrate is sand or a bead, such as a glass bead.

Exemplary Embodiment 3: The solid substrate of embodiment 1, wherein the solid substrate is a glass bead.

Exemplary Embodiment 4: The solid substrate of embodiment 1, wherein the solid substrate is a bead having a diameter from about 150 microns to about 400 microns, preferably from about 210 to about 300 microns.

Exemplary Embodiment 5: The solid substrate of any one of the preceding embodiments, wherein the reagent for chemical synthesis is selected from the group consisting of a reactant, a transition metal source, a coupling ligand, a base, and combinations thereof.

Exemplary Embodiment 6: The solid substrate of any one of the preceding embodiments, wherein the reagent for chemical synthesis is a source of a transition metal.

Exemplary Embodiment 7: The solid substrate of embodiment 6, wherein the transition metal is selected from the group consisting of palladium, copper, and nickel.

Exemplary Embodiment 8: The solid substrate of embodiment 6, wherein the source of the transition metal is a metal-ligand complex.

Exemplary Embodiment 9: The solid substrate of any one of the preceding embodiments, wherein the reagent for chemical synthesis is a coupling ligand.

Exemplary Embodiment 10: The solid substrate of embodiment 9, wherein the coupling ligand is a phosphine ligand.

Exemplary Embodiment 11: The solid substrate of any one of the preceding embodiments, wherein the reagent for chemical synthesis is a base.

Exemplary Embodiment 12: The solid substrate of any one of the preceding embodiments, wherein the reagent for chemical synthesis is present in an amount less than about 20% (w/w), alternatively less than about 10% (w/w), or alternatively less than about 5% (w/w) of the solid substrate.

Exemplary Embodiment 13: The solid substrate of any one of the preceding embodiments, wherein the reagent for chemical synthesis is present in an amount from about 1% to about 20% (w/w), alternatively from about 2% to about 10% (w/w), of the solid substrate.

Exemplary Embodiment 14: The solid substrate of any one of the preceding embodiments, wherein the reagent for chemical synthesis is present in an amount less than about 2 mg, preferably less than about 1 mg, or preferably less than about 0.5 mg.

Exemplary Embodiment 15: The solid substrate of any one of the preceding embodiments, wherein the reagent for chemical synthesis is present in an amount from about 0.01 mg to about 2 mg, preferably from about 0.1 mg to about 1 mg.

Exemplary Embodiment 16: A method for dispensing at least one reagent for chemical synthesis comprising (a) providing a bead, wherein at least one reagent for chemical synthesis is attached to an outer surface of the bead; and (b) dispensing the bead to a reaction vessel.

Exemplary Embodiment 17: The method of embodiment 16, wherein the bead is a glass bead having a diameter from about 150 microns to about 400 microns, preferably from about 210 to about 300 microns.

Exemplary Embodiment 18: The method of embodiment 16 or embodiment 17, wherein the reagent for chemical synthesis is selected from the group consisting of a reactant, a transition metal source, a coupling ligand, a base, and combinations thereof.

Exemplary Embodiment 19: The method of any one of embodiments 16-18, wherein dispensing is automated.

Exemplary Embodiment 20: The method of any one of embodiments 16-19, wherein less than about 2 mg, preferably less than about 1 mg, of the reagent is dispensed.

Exemplary Embodiment 21: The method of any one of embodiments 16-19, wherein the reagent for chemical synthesis is present in an amount less than about 20% (w/w), alternatively less than about 10% (w/w), or alternatively less than about 5% (w/w) of the bead.

Exemplary Embodiment 22: A method for screening a plurality of synthetic reaction conditions comprising the steps of: (a) incubating a solid substrate having at least one reagent for chemical synthesis attached to an outer surface of the solid substrate, at least one reactant, and, optionally, a solvent in a reaction vessel for a time and under conditions sufficient for a desired chemical reaction to occur; and (b) assessing whether the desired chemical reaction occurred.

Exemplary Embodiment 23: The method of embodiment 22, wherein the solid substrate is a bead, such as a glass bead.

Exemplary Embodiment 24: The method of embodiment 22 or embodiment 23, wherein the reagent for chemical synthesis is selected from the group consisting of a reactant, a transition metal source, a coupling ligand, a base, and combinations thereof.

Exemplary Embodiment 25: The method of any one of embodiments 22-24, wherein the reagent for chemical synthesis is a source of a transition metal.

Exemplary Embodiment 26: The method of embodiment 25, wherein the transition metal is selected from the group consisting of palladium, copper, and nickel.

Exemplary Embodiment 27: The method of any one of embodiments 22-26, wherein the reagent for chemical synthesis is a coupling ligand.

Exemplary Embodiment 28: The method of embodiment 27, wherein the coupling ligand is a phosphine ligand.

Exemplary Embodiment 29: The method of any one of embodiments 22-28, wherein the reagent for chemical synthesis is a base.

Exemplary Embodiment 30: A method for making a reagent-coated bulking agent comprising the steps of: (a) combining a reagent and a bulking agent to form a mixture; and (b) applying mechanical energy to the mixture.

Exemplary Embodiment 31: The method of embodiment 30, wherein the mechanical energy is applied using an acoustic mixer.

Exemplary Embodiment 32: The method of embodiment 30 or embodiment 31, wherein the bulking agent is a bead, preferably a glass bead.

Exemplary Embodiment 33: The method of any one of embodiments 30-32, wherein the reagent is selected from the group consisting of a reactant, a transition metal source, a coupling ligand, a base, and combinations thereof.

Exemplary Embodiment 34: The method of any one of embodiments 30-33, wherein the reagent is a source of a transition metal.

Exemplary Embodiment 35: The method of embodiment 34, wherein the transition metal is selected from the group consisting of palladium, copper, and nickel.

Exemplary Embodiment 36: The method of any one of embodiments 30-35, wherein the reagent is a coupling ligand.

Exemplary Embodiment 37: The method of embodiment 36, wherein the coupling ligand is a phosphine ligand.

Exemplary Embodiment 38: The method of any one of embodiments 30-37, wherein the reagent for is a base.

Exemplary Embodiment 39: A reagent-coated bulking agent prepared by the method of any one of embodiments 30-38.

In this disclosure, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

### E. EXAMPLES

The following examples are merely illustrative, and not limiting to this disclosure in any way.

### Example 1

### Accuracy & Reproducibility of Coated Beads

Glass beads (Sigma-Aldrich) and ketoprofen were combined in a mixing vessel. The vessel was capped and placed in an acoustic mixer and mixed for 15 min at 60% intensity (Resodyn Acoustic Mixer) to provide 2% (w/w) reagent-coated beads as described herein.

Glass beads (Sigma-Aldrich) and 1-[Bis(dimethylamino)methylene]-1H-1,2,3-triazolo[4,5-b]pyridinium 3-oxid hexafluorophosphate (HATU) were combined in a mixing vessel. The vessel was capped and placed in an acoustic mixer and mixed for 15 min at 60% intensity (Resodyn Acoustic Mixer) to provide 3% (w/w) reagent-coated beads as described herein.

A solid dispensing unit (SWAVE; Chemspeed® Technologies) was used to dispense 5 mg to 50 mg of coated beads to 4 mL vials. The amount of chemical in each vial was quantified using qNMR (with internal standard). Data are presented in Table 3 and Table 4.

TABLE 3
Ketoprophen-coated beads.

| | Target | Actual | Deviation | |
|---|---|---|---|---|
| Weight of | Compound | Compound | from | % |
| Beads (mg) | Weight (mg) | Weight (mg) | Target (mg) | Deviation |
| 5 | 0.10 | 0.11 | 0.01 | 9.69 |
| 10 | 0.20 | 0.18 | −0.02 | −10.00 |
| 15 | 0.30 | 0.28 | −0.02 | −7.60 |
| 20 | 0.40 | 0.39 | −0.01 | −2.27 |
| 25 | 0.50 | 0.50 | 0.00 | −0.35 |
| 30 | 0.60 | 0.63 | 0.03 | 5.00 |
| 35 | 0.70 | 0.71 | 0.01 | 0.84 |
| 40 | 0.80 | 0.81 | 0.01 | 1.37 |
| 45 | 0.90 | 0.90 | 0.00 | −0.35 |
| 50 | 1.00 | 0.98 | −0.02 | −2.27 |

TABLE 4
HATU-coated beads.

| | Target | Actual | Deviation | |
|---|---|---|---|---|
| Weight of | Compound | Compound | from | % |
| Beads (mg) | Weight (mg) | Weight (mg) | Target (mg) | Deviation |
| 5 | 0.15 | 0.12 | −0.03 | −16.70 |
| 10 | 0.30 | 0.27 | −0.03 | −10.33 |
| 15 | 0.45 | 0.48 | 0.03 | 5.86 |
| 20 | 0.60 | 0.52 | −0.08 | −12.89 |
| 25 | 0.75 | 0.76 | 0.01 | 1.63 |
| 30 | 0.90 | 0.87 | −0.03 | −3.21 |
| 35 | 1.05 | 0.98 | −0.07 | −6.33 |
| 40 | 1.20 | 1.17 | −0.03 | −2.28 |
| 45 | 1.35 | 1.24 | −0.11 | −8.44 |
| 50 | 1.50 | 1.50 | 0.00 | 0 |

As can be seen in the above Tables, the average deviation from target was less than 10%, with higher deviations at lower quantities. For use in chemical reactions, small actual weight differences are not prohibitive, particularly when excess reagent is being used. Thus, the exemplified method to dispense small amounts of solid reagent is reproducible and accurate.

### Example 2

### Stability of Reagent-Coated Beads

Glass beads (Sigma-Aldrich) and Pd(dppf)C12 were combined in a mixing vessel. The vessel was capped and placed in an acoustic mixer and mixed for 15 min at 60% intensity (Resodyn Acoustic Mixer) to provide 2% (w/w) reagent-coated beads as described herein.

Consistency and integrity of the coated beads was assessed initially and after storage for about 6, 12, and 18 months at ambient conditions. Data are presented in Table 5.

TABLE 5
Stability of Pd(dppf)Cl₂-coated beads.

| | Initial | Assessment at | Assessment at | Assessment at |
|---|---|---|---|---|
| Property | Assessment | ~6 mo | ~12 mo | ~18 mo |
| Flowability | Flowable | Flowable | Flowable | Flowable |
| Color | Light brown | Light brown | Light brown | Light brown |
| Unbounded | Not observed | Not observed | Not observed | Not observed |
| material | | | | |
| Purity (NMR) | Pure | Pure | Pure | Pure |
| Error (qNMR) | 4% at 0.65 mg | 6% at 1.4 mg | 6% at 0.7 mg | 5% at 0.7 mg |

### Example 3

### Solid Reagent Dispensing for Micro-Scale Test Library

In the following examples, starting material or core was reacted with a variety of monomers to elucidate monomer(s) to be advanced to a production run. Non-reactive or low purity monomers lead to poor production runs, which wastes core, time and general resources on failed reactions. A micro-scale (e.g., 0.5 mg-1 mg) test library and/or automated dispensing of sub-milligram scale reagents provides for more efficient production runs.

### 3.1. Synthesis of a 5-substituted 2-hydroxybenzoic Acid

Twenty-seven micro-scale reactions were performed as follows: 1 mg starting material (5-bromo-2-hydroxybenzoic acid) was mixed with a boronic acid or pinacol boronic ester monomer (1.5 eq), Cs₂CO₃-coated glass beads, and Pd(dppf)Cl₂-coated glass beads. Glass beads were dispensed to provide 0.3 mg Pd(dppf)Cl₂ per reaction and 4.5 mg of Cs₂CO₃ per reaction. The general reaction scheme is shown in Scheme 3.1:

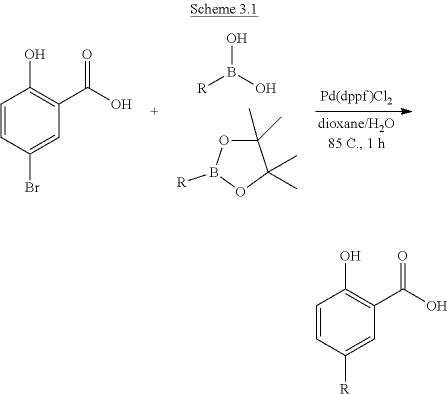

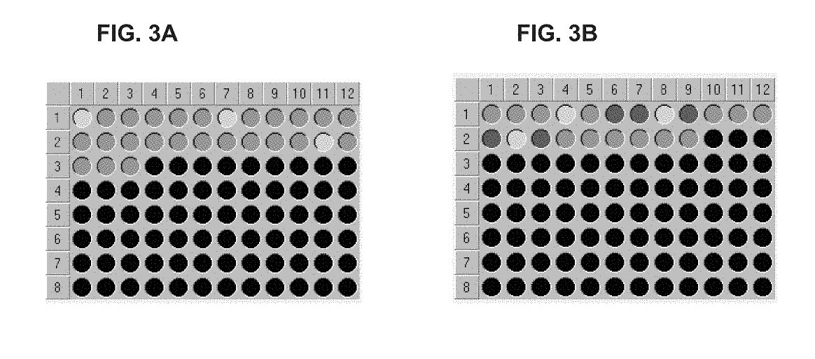

Results from the micro-scale test library are shown in FIG. 3A.

### 3.2. Synthesis of a 1-substituted pyrrolo[2,3-c]pyridin-5yl)acetamide

Twenty-one micro-scale reactions were performed as follows: 1 mg starting material was mixed with a bromide or chloride monomer (3 eq), NaI, and Cs₂CO₃-coated glass beads. Glass beads were dispensed to provide 0.9 mg Cs₂CO₃ per reaction. The general reaction scheme is shown in Scheme 3.2:

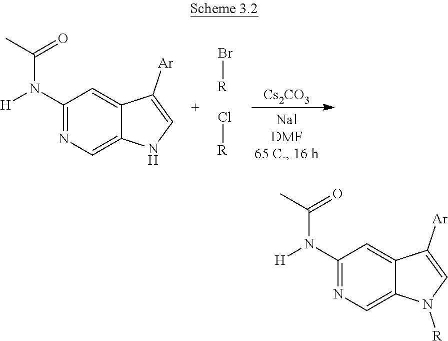

Results from the micro-scale test library are shown in FIG. 3B.

In sum, the micro-scale (e.g., 0.5 mg-1 mg) test libraries provided predictive outcome of library success rate using a minimal amount of core/starting material. Moreover, the micro-scale test libraries allowed for non-reactive monomers to be purged prior to production runs, further saving precious core, time and general resources. Reducing a large library to a manageable size can aid in the drug development process.

### Example 4

### Solid Reagent Dispensing for Reaction Condition Screening

In the following examples, starting material or core was reacted with a boronic acid or 4,4,5,5-tetramethyl-1,3,2-dioxaborolane monomer under a variety of reaction conditions to identify successful reaction conditions. Typically, identifying successful reaction conditions is time and material intensive and limited amount of available core may prevent extensive testing of reaction conditions. However, micro-scale (e.g., 0.5 mg-1 mg) reaction condition screening and/or automated dispensing of sub-milligram amounts of reagents can provide for more efficient production runs and preserve reagents, including reactants.

### 4.1. Synthesis of a methyl 1-(4′-(4-(o-tolyl)thieno [2,3-d]pyrimidin-5-yl)

Fourteen micro-scale reactions were performed as follows: 1 mg starting material (core) was mixed with o-tolylboronic acid and reagent-coated glass beads. In this example, the Pd source and ligand were provided by reagent-coated beads, while the base was dissolved in water and added to the reaction vessel. The reactions were run in 4:1 dioxane/water at 85° C. for 16 hours. The different conditions in each of the fourteen reactions are summarized in Table 6 and the general reaction scheme is shown in Scheme 4.1.

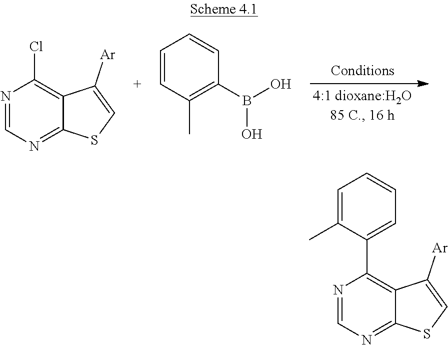

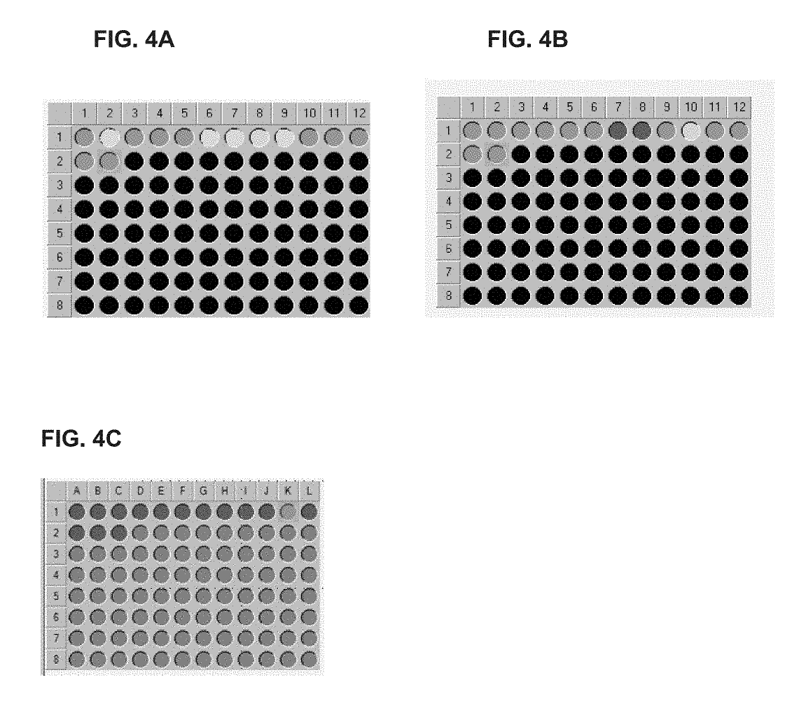

Results from the micro-scale reaction condition screening are shown in FIG. 4A. By crude UPLC, yellow wells had at least some trace of product mass; green wells had ˜30% or greater amount of conversion to product. Condition #1 gave nearly complete conversion, very cleanly. The reaction was scaled using condition #1 to provide 14 mg to isolate (13 mg, 57%) the desired compound

### 4.2. Synthesis of a 5-methoxy-8-(6-methylpyridine-3-yl)-1,2,3,4-tetrahydronaphthalene

Fourteen micro-scale reactions were performed as follows: 1 mg starting material (core) was mixed with 2-methyl-5-(4,4,5,5-tetramethyl-1,3,2-dioxaborolan-2-yl)pyridine and reagent-coated glass beads. In this example, the Pd source and ligand were provided by reagent-coated beads, while the base was dissolved in water and added to the reaction vessel. The reactions were run in 4:1 dioxane/water at 85° C. for 24 hours. The different conditions in each of the fourteen reactions are summarized in Table 7 and the general reaction scheme is shown in Scheme 4.2.

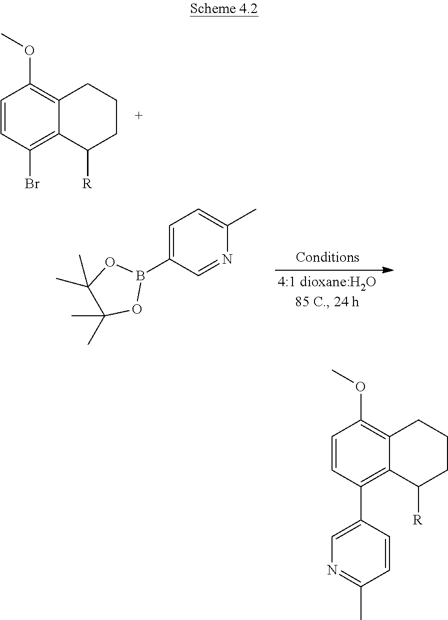

Results from the micro-scale reaction condition screening are shown in FIG. 4B. By crude UPLC, yellow wells had at least some trace of product mass; green wells had ˜30% or greater amount of conversion to product. The reaction was scaled using condition #12 to provide 30 mg to isolate (5.7 mg, 19%) the desired compound.

### 4.3. Synthesis of a 3-ether-2-aryl-pyridine

Fifteen micro-scale reactions were performed as follows: 0.5 mg of starting material (core) was mixed with an alcohol and reagent-coated glass beads. In this example, the catalyst, ligand and base were provided by reagent-coated beads and added to the reaction vessel. The reactions were run 110° C. for 20 hours. The different conditions in each of the fifteen reactions are summarized in Table 8, and the general reaction scheme is shown in Scheme 4.3.

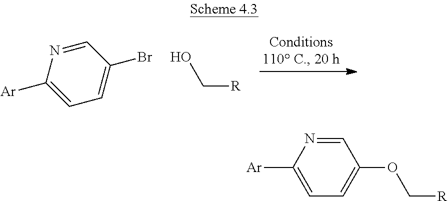

Results from the micro-scale reaction condition screening are shown in FIG. 4C. By crude UPLC, only one well showed product. The reaction was repeated using condition #11 to isolate 18% of the desired compound.

### Example 5

### Flowability of Glass Beads

To measure the flowability of reagent-coated glass beads versus the native chemicals, shear tests were carried out with reagent-coated glass beads (5% w/w except Cs₂CO₃, which was 10% w/w) and the original chemicals in 20 mL vials. Starting from a flat surface (friction angle=0), each 20 mL vial was tilted until sliding of the material occurred. The angle when sliding occurs was recorded as the angle of internal friction as a measurement of flowability of the material (a lower angle of internal friction indicates higher flowability). Results are summarized in Table 9.

TABLE 9

| | Angle of Internal Friction | |
|---|---|---|
| | Glass Beads | Native Chemical |
| Glass Beads (uncoated) | 35 | NA |
| Cs₂CO₃ | 45 | 65 |
| tBuXPhos Pd G3 | 40 | >90 |
| 2,6-Dimethylanilino(oxo)acetic acid | 40 | 85 |
| Ni(PPh₃)₂(o-tolyl)Cl | 40 | 70 |
| CuCl | 35 | 75 |
| CuI | 35 | 70 |
| TrixiePhos Pd G3 | 35 | 75 |
| Cu(OAc)₂ | 35 | 55 |
| Josiphos Pd G3 | 35 | >90 |
| RockPhos Pd G3 | 40 | 60 |
| DavePhos Pd G3 | 35 | >90 |

### Example 6

### Coating Polystyrene Beads

Following the same coating procedure as used above for glass beads, Pd₂(dba)₃ (5% w/w) was successfully coated on polystyrene beads (Advance ChemTech SP5070). The coated polystyrene beads have a similar consistency and solid characteristics as the uncoated polystyrene beads. The coated polystyrene beads can be used in a similar way as the coated glass beads for reaction setup.

### Example 7

### Coating Bases on Glass Beads

Certain chemicals, especially bases, may require longer coating time at 70% intensity than other chemicals. Additionally, certain chemicals, especially bases, may require a milling step to decrease the particle size before the coating process.

The milling process included adding 15 milling balls (3 mm yttrium stabilized zirconium) to 5 g of a chemical in a 20 mL plastic vial and mixing in a Resodyn LabRAM for 15-30 minutes at 70% intensity. The milled material can then be coated on glass beads using the established protocol.

Table 10 presents the percent loading achieved for various milled bases mixed at 70% intensity using the Resodyn LabRAM for the indicated time. For the milled bases listed below, a loading as high as 20% can be achieved.

TABLE 10

| | | Highest Loading |
|---|---|---|
| Chemicals | Coating time (min) | (w/w) Achieved |
| CS₂CO₃ | 30 + cool down + 30 | 20 |
| K₂CO₃ | 60 | 10 |
| CsF | 30 | 20 |
| KOtBu | 30 | 10 |
| NaOtBu | 30 | 10 |
| K₃PO₄ | 15 | 20 |

### Example 8

### Mixed Reagent-Coated Beads (Catalyst and Ligand)

Reagent-coated glass beads with catalyst (BrettPhos Pd G3 0.08 mmol/g) and ligand (RuPhos 0.16 mmol/g) on the same beads were created by first coating the catalyst on glass beads using the established protocol followed by adding appropriate amount of ligand and repeat the coating process.

The amount of each chemical reagent on the glass beads was quantified by both quantitative nuclear magnetic resonance spectroscopy (qNMR) and ultra-violet (UV) absorbance methodologies.

qNMR Method: Mixed reagent-coated beads containing BrettPhos Pd G3 (0.08 mmol/g) and RuPhos (0.16 mmol/g) were made. Samples of reagent-coated beads of various weights were suspended in NMR solvent (CD₃OD) with maleic acid as internal standard to dissolve the coated chemicals. The concentrations of each chemical were then quantified by comparing selected NMR peak integrations with the maleic acid peak integration.

Results of quantification by qNMR are presented in Table 11. Based on the qNMR results, the two chemicals coated evenly on the glass beads, and the ratio of the 2 chemicals remained constant.

TABLE 11

| | BrettPhos Pd G3 | | | RuPhos | | |
|---|---|---|---|---|---|---|
| Bead | qNMR | Calcu- | | qNMR | Calcu- | |
| Weight | mass | lated | Differ- | mass | lated | Differ- |
| (mg) | (mg) | (mg) | ence % | (mg) | (mg) | ence % |
| 58 | 4.90 | 4.74 | 3.4 | 4.22 | 4.45 | 5.4 |
| 64 | 5.44 | 5.23 | 3.9 | 4.74 | 4.91 | 3.6 |
| 37 | 3.31 | 3.02 | 8.6 | 2.91 | 2.84 | 2.4 |
| 43 | 3.79 | 3.51 | 7.3 | 3.46 | 3.30 | 4.7 |
| 43 | 3.89 | 3.51 | 6.1 | 3.14 | 3.30 | 4.9 |
| 15 | 1.28 | 1.23 | 4.6 | 1.18 | 1.15 | 2.9 |
| 12 | 0.95 | 0.98 | 3.4 | 0.96 | 0.92 | 3.8 |
| 10 | 0.92 | 0.85 | 7.7 | 0.86 | 0.80 | 6.8 |
| 9.0 | 0.69 | 0.69 | 0.9 | 0.68 | 0.65 | 3.5 |
| 7.0 | 0.50 | 0.54 | 7.8 | 0.51 | 0.51 | 0.8 |

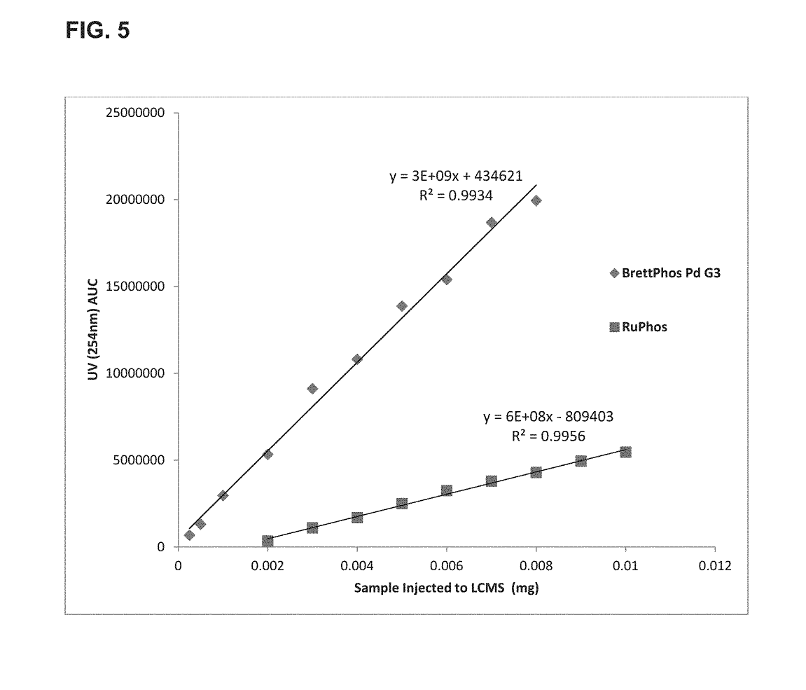

UV Method: Mixed reagent-coated beads containing BrettPhos Pd G3 (0.08 mmol/g) and RuPhos (0.16 mmol/g) were made. Calibration curves of each chemical were established by serial dilution of stock solutions made from uncoated chemicals. Samples of various concentration were injected into a HPLC instrument, and the intensity (area under the curve) of UV absorbance of each chemical at various concentrations were recorded and plotted in FIG. 5.

UV Quantification-Mixed Reagent-Coated Beads: Samples of reagent-coated beads with various weights were suspended in methanol to dissolve the coated chemical and injected into a HPLC instrument; the intensity (area under the curve) of UV absorbance of each sample was recorded. The UV absorbance data and the established calibration curve were then used to calculate the amount of chemicals in each reagent-coated bead.

Results of quantification by UV are presented in Table 12. Based on the UV results, the two chemicals coated evenly on the glass beads, and the ratio of the 2 chemicals remained constant.

TABLE 12

| | BrettPhos Pd G3 | | | RuPhos | | |
|---|---|---|---|---|---|---|
| Bead | Mea- | Calcu- | | Mea- | Calcu- | |
| Weight | sured | lated | % Differ- | sured | lated | % Differ- |
| (mg) | (mg) | (mg) | ence | (mg) | (mg) | ence |
| 12.5 | 0.95 | 1.02 | 6.8 | 1.05 | 0.96 | 9 |
| 17.6 | 1.33 | 1.44 | 7.5 | 1.46 | 1.35 | 8.5 |
| 25.1 | 1.93 | 2.05 | 6 | 1.77 | 1.92 | 7.8 |
| 27.9 | 2.07 | 2.28 | 9 | 2.30 | 2.14 | 7.4 |

An exemplary reaction scheme using a mixed reagent-coated bead is shown in Scheme 8.1. The reactivity of the mixed reagent-coated beads containing catalyst and ligand was tested with the reaction below, and the result indicated that mixed reagent-coated beads have the same reactivity as using the reagent-coated beads with each chemical coated on separate beads (catalyst and ligand). One advantage of the mixed reagent-coated beads containing both catalyst and ligand is the simplicity of reaction set up.

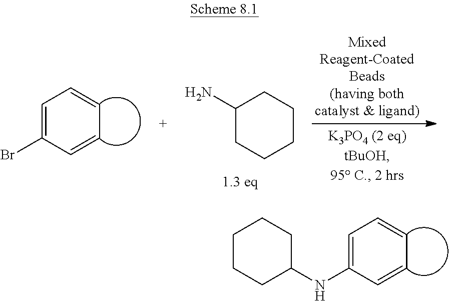 [SMILES: Brc1ccccc1 ; NC1CCCCC1 ; c1ccc(NC2CCCCC2)cc1]

### Example 9

### Mixed Reagent-Coated Beads (Catalyst, Ligand, and Base)

Reagent-coated glass beads with catalyst (BrettPhos Pd G3 0.01 mmol/g), ligand (RuPhos 0.02 mmol/g) and base (K₃PO₄ 0.24 mmol/g) were created by first coating the catalyst on glass beads using the established protocol, followed by coating of the ligand and then the base.

An exemplary reaction scheme using a mixed reagent-coated bead is shown in Scheme 9.1. The reactivity of the mixed reagent-coated beads containing catalyst, ligand, and base was tested with the reaction below, and the result indicated that mixed reagent-coated beads have the same reactivity as using the reagent-coated beads with each chemical coated on separate beads (catalyst, ligand, and base). One advantage of the mixed reagent-coated beads containing catalyst, ligand, and base is the simplicity of reaction set up.

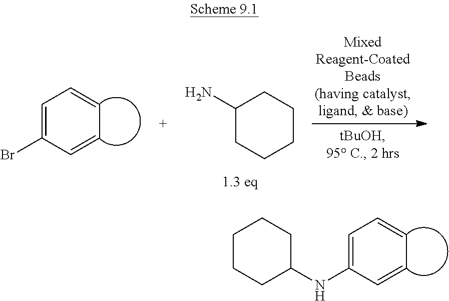 [SMILES: Brc1ccccc1 ; NC1CCCCC1 ; c1ccc(NC2CCCCC2)cc1]

### Example 10

### Nanomole Scale Reaction

Reaction miniaturization can be achieved by using one (1) single bead containing the catalyst, ligand and base.

An exemplary reaction scheme using a single mixed reagent-coated bead is shown in Scheme 10.1.

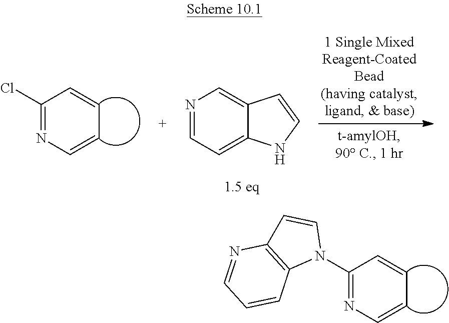 [SMILES: Clc1ccccn1 ; c1cc2[nH]ccc2cn1 ; c1ccc(-n2ccc3ncccc32)nc1]

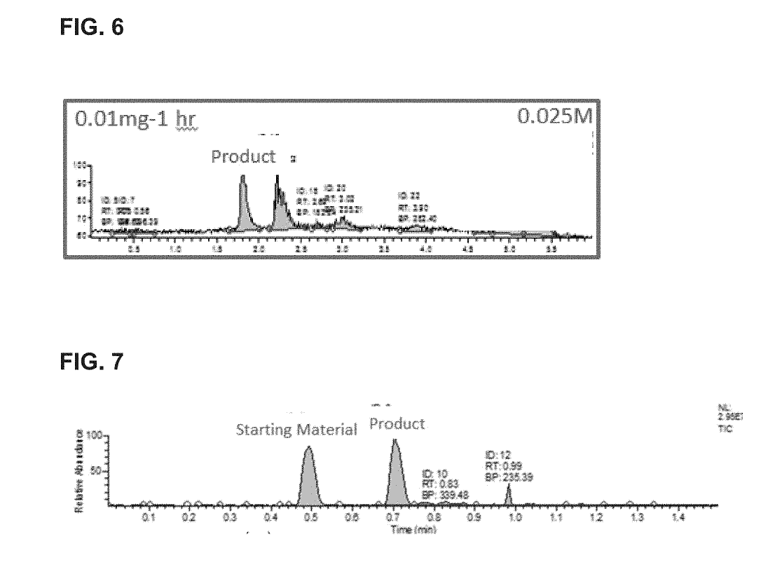

The two coupling partners and one single mixed reagent-coated bead containing catalyst, ligand, and base were added to a vial, and the solvent t-amylOH was added under a nitrogen atmosphere. The mixture was heated to 90° C. for 2 hrs. LCMS analysis (shown in FIG. 6) indicated formation of the desired product.

### Example 11

### Combination-Catalyst-Coated Beads and Combination-Base-Coated Beads

Fifteen catalysts (see Table 13 below) commonly used for Suzuki couplings (0.006 mmol/g each) were placed in a 20 mL glass vial. The mixture was mixed thoroughly using a Resodyn LabRAM (5 minutes at 60% intensity). The mixture was then coated on 20 g of glass beads using the established protocol to make combination-reagent-coated (combination-catalyst-coated) beads.

The same method was used to generate combination-base-coated beads (0.16 mmol/g) containing 3 common bases: Cs₂CO₃, K₃PO₄, and KOtBu (see Table 14 below).

TABLE 13

| Catalyst | MW | Chemical used (g) |
|---|---|---|
| Pd(dppf)Cl₂ | 816 | 0.09 |
| Pd₂(dba)₃ | 915 | 0.1 |
| P(tBu)₃ Pd G3 | 572 | 0.065 |
| PdCl₂(dtbpf) | 651 | 0.075 |
| Xphos Pd G3 | 846 | 0.093 |
| PdCl₂(PCy₃)₂ | 738 | 0.085 |
| PdCl₂(PPh₃)₂ | 701 | 0.08 |
| PdCl₂(dppe) | 575 | 0.065 |
| Pd(DPEPhos)Cl₂ | 715 | 0.08 |
| Pd(Xantphos)Cl₂ | 755 | 0.085 |
| Pd(Amphos)Cl₂ | 708 | 0.08 |
| PEPPSI-iPent | 791 | 0.085 |
| SPhos Pd G3 | 780 | 0.085 |
| PA Pd G3 | 662 | 0.075 |
| PEPPSI-iPr | 679 | 0.075 |

TABLE 14

| Base | MW | Chemical Used (g) |
|---|---|---|
| Cs₂CO₃ | 325 | 1.1 |
| K₃PO₄ | 212 | 0.7 |
| KOtBu | 112 | 0.35 |

An exemplary reaction scheme using the combination-catalyst-coated bead and the combination-base-coated bead is shown in Scheme 11.1.

To 6-bromoquinazoline 1 (10 mg, 0.048 mmol) and phenylboronic acid 2 (7.01 mg, 0.058 mmol) in a 4 mL vial was added 40 mg of combination-catalyst-coated beads (5 mmol %), 60 mg of combination-base-coated beads (0.096 mmol) and 0.5 mL of dioxane/water (4:1). The reaction was heated to 90° C. for 1 hour.

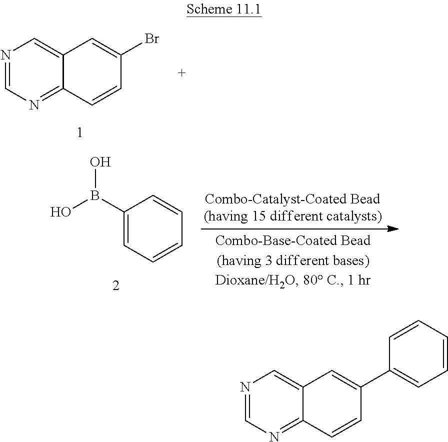 [SMILES: Brc1ccc2ncncc2c1 ; OB(O)c1ccccc1 ; c1ccc(-c2ccc3ncncc3c2)cc1]

LCMS analysis (shown in FIG. 7) indicated formation of the desired product. One advantage of the combination-catalyst-coated beads and the combination-base-coated beads is to produce the desired product with one easy setup, minimizing the number of experimental trials.

### Example 12

### Micro-Scale Test Library

A micro-scale test library can be used as tool to predict the outcome of a production scale library synthesis.

A library of 28 coupling reactions (0.5 mg each) between Compound A and Compound M (one of 28 different carboxylic acids, M1-M28) was set up using HATU-coated glass beads (5% w/w) (1.3 equiv) and triethylamine (5 equiv) in 2 mL vials. The vials were heated to 80° C. for 4 hours.

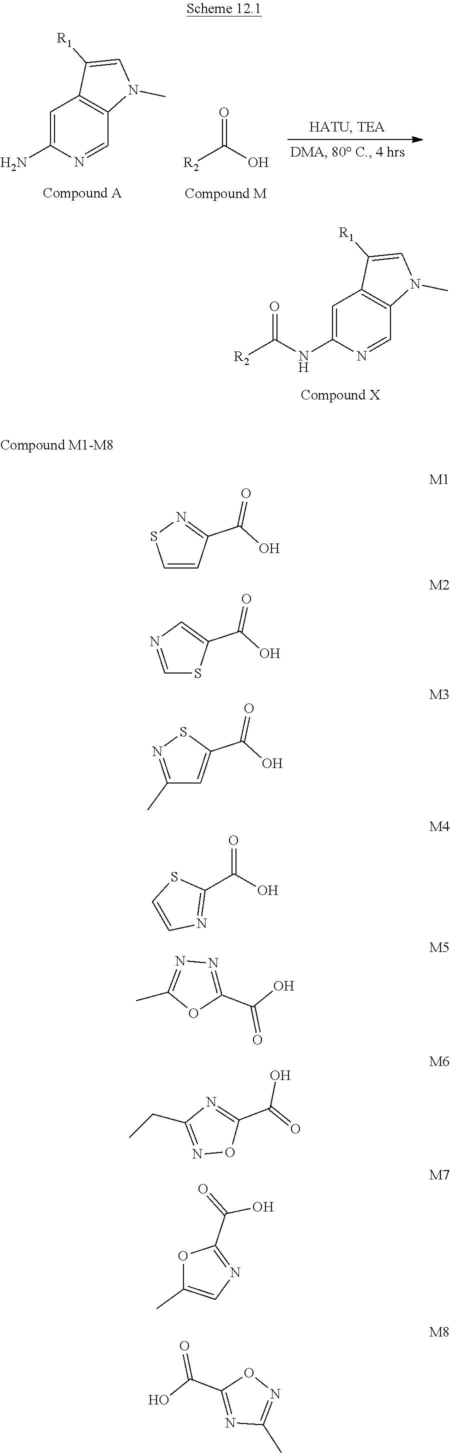

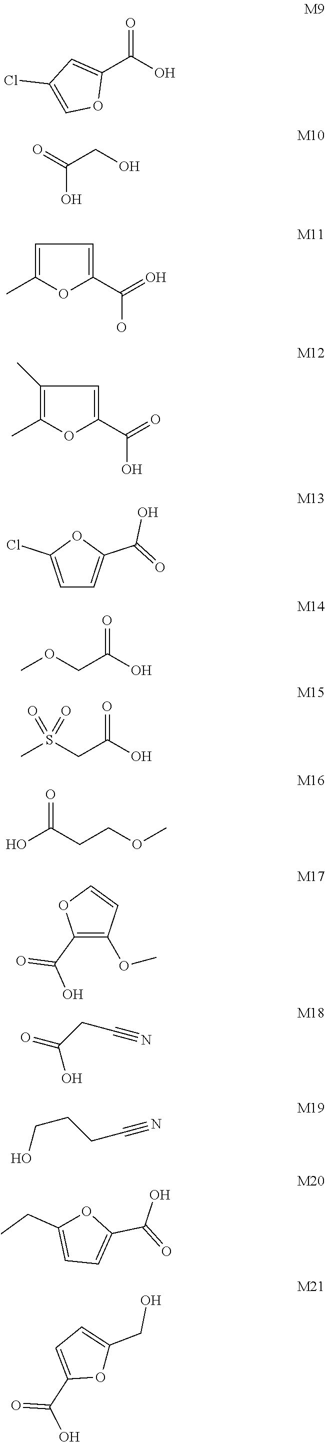

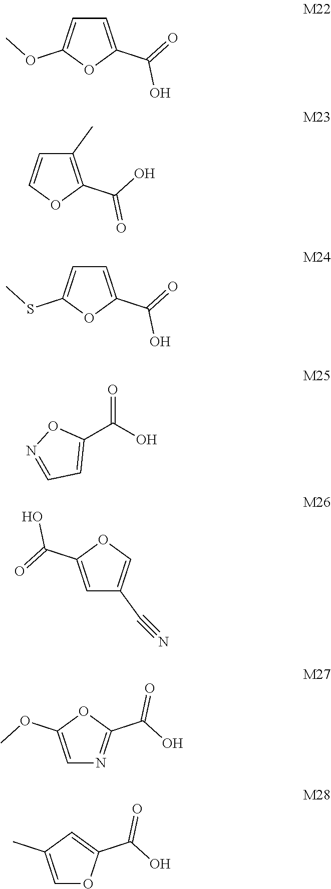

A production scale (25 mg each) library of the same compounds was set up under the same conditions as in the micro-scale test library (except no reagent-coated glass beads were used).

Analysis was by LCMS. The results of the micro-scale reaction (using reagent-coated glass beads) and the production scale reaction are summarized in Table 15. The results indicated good correlations between the micro-scale test library and the production scale library.

TABLE 15

| | | | Isolated | Product |
|---|---|---|---|---|
| | MicroScale | | Product | Amount |
| Rxn | Test Library | Production Library | Yield (%) | (mg) |
| 1 | Product Detected | Product Detected | 11.92 | 5.1 |
| 2 | Product Detected | Product Detected | 32.49 | 13.9 |
| 3 | Product Detected | Sample Impure | 5.65 | 2.48 |
| 4 | Product Not | Product Not Detected | 0.00 | 0 |
| | Detected | | | |
| 5 | Product Not | Product Not Detected | 0.91 | 0.39 |
| | Detected | | | |
| 6 | Product Detected | Product Detected | 15.43 | 6.76 |
| 7 | Product Detected | Product Detected | 15.13 | 6.45 |
| 8 | Product Not | Product Not Detected | 0.00 | 0 |
| | Detected | | | |
| 9 | Product Detected | Product Detected | 12.75 | 5.63 |
| 10 | Product Detected | Product Detected | 9.98 | 3.85 |
| 11 | Product Detected | Product Detected | 36.91 | 15.7 |
| 12 | Product Detected | Product Detected | 13.52 | 5.9 |
| 13 | Product Detected | Product Detected | 12.25 | 5.41 |
| 14 | Product Detected | Product Detected | 46.86 | 18.6 |
| 15 | Product Detected | Product Detected | 21.11 | 9.18 |
| 16 | Product Detected | Product Detected | 51.59 | 21.05 |
| 17 | Product Detected | Product Detected | 39.70 | 17.39 |
| 18 | Product Not | Product Not Detected | 0.00 | 0 |
| | Detected | | | |
| 19 | Product Detected | Product Detected | 32.92 | 13.3 |
| 20 | Product Detected | Product Detected | 41.10 | 17.94 |
| 21 | Product Detected | Product Detected | 43.53 | 19.07 |
| 22 | Product Detected | Product Detected | 31.05 | 13.6 |
| 23 | Product Detected | Product Detected | 20.64 | 8.78 |
| 24 | Product Detected | Product Detected | 28.80 | 12.98 |
| 25 | Product Not | Product Not Detected | 0.00 | 0 |
| | Detected | | | |
| 26 | Product Detected | Product Detected | 19.88 | 8.63 |
| 27 | Product Not | Product Not Detected | 0.00 | 0 |
| | Detected | | | |
| 28 | Product Detected | Product Detected | 17.68 | 7.52 |

### Example 13

### Photoredox Reactions

The reaction set up was done in a dry box. In a 1.0 mL glass tube containing a stir bar, 25 mg glass beads coated with nickel(II) chloride ethylene glycol dimethyl ether complex (5% by weight,1.25 mg) was pre-mixed with 30.4 mg glass beads coated with 4,4-di-tert-butyl-2,2-dipyridyl (5% by weight, 1.52 mg) in 0.7 mL of dioxane for 10 minutes. The resulting mixture was transferred to a 1.0 mL glass microtube containing potassium cyclopentyltrifluoroborate (20 mg, 0.11 mmol), an aryl bromide (0.17 mmol) and [Ir{dFCF₃ppy}₂(bpy)]PF₆ (3.4 mg, 0.003 mmol), followed by addition of 2,6,-Lutidine (120 uL, 0.17 mmol). The microtube was sealed and placed in a photoredox reactor under blue LED for 24 hours. The crude reaction was filtered, checked by LC/MS and purified by reverse phase HPLC to provide the product shown in Table 16; the four products were obtained following the same procedure as described above.

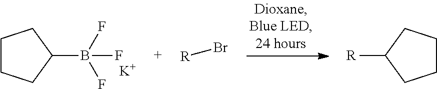

For comparison, the four reactions were set up exactly the same way but without reagent-coated glass beads. In these cases, 1.25 mg of nickel(II) chloride ethylene glycol dimethyl ether complex and 1.52 mg of 4,4-di-tert-butyl-2,2-dipyridyl were used instead.

TABLE 16

| | | Isolated Yields |
|---|---|---|
| | Isolated Yields using | without Reagent- |
| Product Structure | Reagent-Coated beads | Coated beads |
| 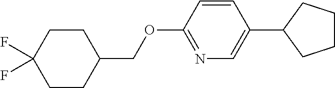 [SMILES: FC1(F)CCC(COc2ccc(C3CCCC3)cn2)CC1] | 19% | 15% |
| 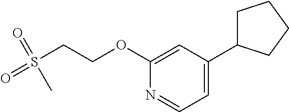 [SMILES: CS(=O)(=O)CCOc1cc(C2CCCC2)ccn1] | 16% | 22% |
| 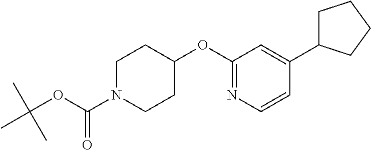 [SMILES: CC(C)(C)OC(=O)N1CCC(Oc2cc(C3CCCC3)ccn2)CC1] | 35% | 31% |
| 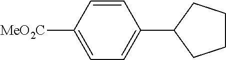 [SMILES: COC(=O)c1ccc(C2CCCC2)cc1] | 29% | 33% |

Comparison of the isolated yields demonstrates that reagent-coated glass beads can be effectively used in photoredox reactions.

### Example 14

### Manual Set-Up of a Millimole Scale Library

With its high flowability and favorable solid properties, reagent-coated beads can be used to conveniently set up reactions in parallel on a millimole scale by adding reagent-coated beads manually with a scoop.

A library of 62 coupling reactions of 35 mg of bromide core (0.16 mmol) and 62 different boronic acids (0.19 mmol, 1.2 equiv) was set up by adding each to a 4 mL vial along with XPhos Pd G2-coated glass beads (5% w/w, 1 mol %), XPhos-coated glass beads (5% w/w, 2 mol %), K₂CO₃ (1.05 equiv) and ethanol/water (2 mL, 4:1). The vials were heated to 80° C. for 16 hours. A total of 55 desired products were isolated with a 93% success rate and 20% average isolated yield.

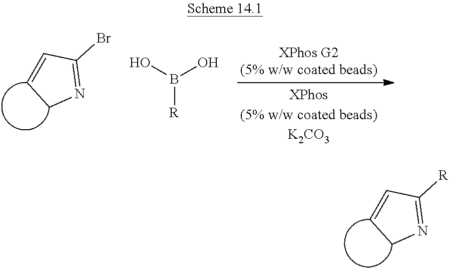

It is understood that the foregoing detailed description and accompanying examples are merely illustrative and are not to be taken as limitations upon the scope of the invention, which is defined solely by the appended claims and their equivalents. Various changes and modifications to the disclosed embodiments will be apparent to those skilled in the art. Such changes and modifications, including without limitation those relating to the chemical structures, substituents, derivatives, intermediates, syntheses, formulations, or methods, or any combination of such changes and modifications of use of the invention, may be made without departing from the spirit and scope thereof.

All references (patent and non-patent) cited above are incorporated by reference into this patent application. The discussion of those references is intended merely to summarize the assertions made by their authors. No admission is made that any reference (or a portion of any reference) is relevant prior art (or prior art at all). Applicant reserves the right to challenge the accuracy and pertinence of the cited references.

What is claimed is:

1. A solid substrate comprising an outer surface and at least one reagent for chemical synthesis attached to the outer surface, wherein the reagent for chemical synthesis is attached to the outer surface by an application of mechanical energy to a mixture comprising the reagent for chemical synthesis and the solid substrate.

2. The solid substrate of claim 1, wherein the solid substrate is a glass bead or a polystyrene bead.

3. The solid substrate of claim 1, wherein the solid substrate is a bead having a diameter from about 150 microns to about 400 microns.

4. The solid substrate of any one of the preceding claims, wherein the reagent for chemical synthesis is selected from the group consisting of a reactant, a transition metal source, a coupling ligand, a base, and combinations thereof.

5. The solid substrate of any one of the preceding claims, wherein the reagent for chemical synthesis is present in an amount from about 1% to about 20% (w/w).

6. A kit comprising a solid substrate of claim 1.

7. A method for making a reagent-coated bulking agent comprising the steps of:
(a) combining a reagent and a bulking agent to form a mixture; and
(b) applying mechanical energy to the mixture.

8. The method of claim 7, wherein the mechanical energy is applied using an acoustic mixer.

9. The method of claim 7, wherein the bulking agent is a glass bead or a polystyrene bead.

10. The method of claim 7, wherein the reagent is selected from the group consisting of a reactant, a transition metal source, a coupling ligand, a base, and combinations thereof.

11. A reagent-coated bulking agent prepared by the method of claim 7.

12. The reagent-coated bulking agent of claim 11, wherein the bulking agent is a glass bead or a polystyrene bead.

13. A method for dispensing at least one reagent for chemical synthesis comprising the steps of:
(a) providing a reagent-coated bead, wherein at least one reagent for chemical synthesis is attached to an outer surface of the bead via an application of mechanical energy to a mixture comprising the reagent for chemical synthesis and an uncoated bead; and
(b) dispensing the reagent-coated bead to a reaction vessel.

14. The method of claim 13, wherein the reagent-coated bead is a glass bead having a diameter from about 150 microns to about 400 microns.

15. The method of claim 13, wherein the reagent for chemical synthesis is selected from the group consisting of a reactant, a transition metal source, a coupling ligand, a base, and combinations thereof.

16. The method of claim 13, wherein dispensing is automated.

17. The method of claim 13, wherein the reagent for chemical synthesis is present in an amount from about 1% to about 20% (w/w).

18. The method of claim 13, further comprising:
(c) incubating the reagent-coated bead, at least one reactant, and, a solvent in the reaction vessel for a time and under conditions sufficient for a desired chemical reaction to occur; and
(d) assessing whether the desired chemical reaction occurred.

19. The method of claim 18, wherein the reagent-coated bead is a glass bead having a diameter from about 150 microns to about 400 microns.

20. The method of claim 18, wherein the reagent for chemical synthesis is selected from the group consisting of a reactant, a transition metal source, a coupling ligand, a base, and combinations thereof.
